(19) United States
(12) Patent Application Publication
(10) Pub. No.: US 2018/0241122 A1
(43) Pub. Date: Aug. 23, 2018

(54) DISTRIBUTED PHASE SHIFTER ARRAY SYSTEM AND METHOD

(71) Applicant: Space Exploration Technologies Corp., Hawthorne, CA (US)

(72) Inventors: Shahrzad Jalali Mazlouman, Redmond, WA (US); Kim Schulze, Redmond, WA (US)

(21) Appl. No.: 15/898,507

(22) Filed: Feb. 17, 2018

Related U.S. Application Data
(60) Provisional application No. 62/460,203, filed on Feb. 17, 2017.
(60) Provisional application No. 62/631,195, filed on Feb. 15, 2018.

(51) Int. Cl. H01Q 3/34; H01P 1/18; H01Q 21/06

(52) U.S. Cl. CPC H01Q 3/34; H01Q 21/061; H01P 1/18

(57) ABSTRACT

In embodiments, an apparatus includes a two-dimensional (2-D) array of phase shifters including a first plurality of the phase shifters and a second plurality of the phase shifters. The first plurality of the phase shifters is arranged in a first direction of the 2-D array of phase shifters. The first plurality of the phase shifters is electrically connected to a first radio frequency (RF) input. The second plurality of the phase shifters is arranged in a second direction of the 2-D array of phase shifters. The second plurality of the phase shifters is electrically connected to a first radio frequency (RF) output. The first and second directions intersect each other.

### CROSS-REFERENCE TO RELATED APPLICATIONS

This application claims the benefit of U.S. Provisional Patent Application No. 62/460,203 filed Feb. 17, 2017, and U.S. Provisional Patent Application No. 62/631,195 filed Feb. 15, 2018, both disclosures hereby incorporated by reference in their entirety herein.

### BACKGROUND

An antenna (such as a dipole antenna) typically generates radiation in a pattern that has a preferred direction. For example, the generated radiation pattern is stronger in some directions and weaker in other directions Likewise, when receiving electromagnetic signals, the antenna has the same preferred direction. Signal quality (e.g., signal to noise ratio or SNR), whether in transmitting or receiving scenarios, can be improved by aligning the preferred direction of the antenna with a direction of the target or source of signal. However, it is often impractical to physically reorient the antenna with respect to the target or source of signal. Additionally, the exact location of the source/target may not be known. To overcome some of the above shortcomings of the antenna, a phased array antenna can be formed from a set of antenna elements to simulate a large directional antenna. An advantage of a phased array antenna is its ability to transmit and/or receive signals in a preferred direction (e.g., the antenna's beamforming ability) without physical repositioning or reorientation.

An incoming radio frequency (RF) signal arriving at the antenna elements as a set of wave fronts may be detected by respective antenna elements at different times from each other. Therefore, the same signal from a RF source may include phase offsets from one antenna element to another antenna element. The phase offsets may be adjusted with respect to a same reference by phase shifters coupled to the antenna elements, such that the phase offset among the individual antenna elements may be canceled and the signals received at the different antenna elements may be constructively and coherently combined. The phase-corrected RF signals may be additionally processed to result in a received signal having a high SNR.

Signals between antenna elements and phase shifters (e.g., phase shifter chips) may be routed through traces formed on printed circuit boards (PCBs). The number of phase shifter chips included in a phased array antenna system may be large, especially for systems capable of receiving and/or transmitting multiple beams. Locating the phase shifter chips (e.g., surface mounted on PCBs) and/or the traces associated with the phase shifter chips on PCBs may add to the complexity of PCBs, such as inclusion of a large number of routing layers. Depending on the routing scheme of the traces, relatively long trace lengths may result, which, in turn, increases signal attenuation, power dissipation, and/or complexity.

Electromagnetic (EM) couplings between these routings may also be hard to control. Furthermore, for high frequency signals (e.g., gigahertz (GHz) range signals) the parasitic capacitances lower cutoff frequency and limit the bandwidth of the RF system. As a result, conventional phased antenna arrays operate in a relatively narrow frequency band while dissipating relatively high power.

It would be advantageous to configure phased array antennas having increased bandwidth while maintaining a high ratio of the main lobe power to the side lobe power. Likewise, it would be advantageous to configure phased array antennas having reduced weight, reduced size, lower manufacturing cost, and/or lower power requirements. Accordingly, embodiments of the present disclosure are directed to these and other improvements in phase array antennas or portions thereof.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Most phased array antennas require a large number of phase shifter components for controlling the phase of the signal received-by or emitted-from individual antenna elements to control the angle of beamforming. With some embodiments of the present disclosure, an array of multiple phase shifters may be built on an integrated circuit (IC) chip (e.g., a semiconductor die). As a result, the cost, size, area, complexity, and power requirements of the phased array antenna system can be reduced. The present disclosure may be implementable, for example, as a two-dimensional (2-D) array of antennas for multi-beam receiving elements (e.g., an M×N array). In some embodiments, the array of antennas can be one-dimensional (1-D) (e.g., M=1 or N=1). Since multiple phase shifters can be built on a single chip, the cost, size, and weight of the chip package can also be reduced. Furthermore, signal routing (e.g., trace routing), which includes distributing RF signals among phase shifters, can at least partially be implemented on the chip, as compared to the printed circuit board (PCB)-based signal routing of the conventional technology. In some embodiments, several chips each including multiple phase shifters can be combined into one phased array antenna system.

In some IC chip designs, parasitic capacitance may limit the frequency of transmitted signals because the cutoff frequency becomes too low, especially for gigahertz (GHz)-range signals. In some embodiments of the present disclosure, the parasitic capacitance can be absorbed by discrete inductors built on the IC chip or by inductance of the conductive traces of the IC. In some embodiments, the inputs and/or outputs of the IC chip can be terminated by optimal tunable resistors and/or balun transformers for better impedance matching (thereby transferring optimal power) and reduce noise from lower reflected RF waves. In some embodiments, an apparatus includes a two-dimensional (2-D) array of phase shifters including a first plurality of the phase shifters and a second plurality of the phase shifters, wherein the first plurality of the phase shifters is arranged in a first direction of the 2-D array of phase shifters, and wherein the first plurality of the phase shifters is electrically coupled to a first radio frequency (RF) input. The second plurality of the phase shifters is arranged in a second direction of the 2-D array of phase shifters, and wherein the second plurality of the phase shifters is electrically coupled to a first radio frequency (RF) output. The first and second directions intersect each other.

In some embodiments, a method for phased array beamforming includes receiving a first radio frequency (RF) input signal; phase shifting the first RF input signal by a first plurality of phase shifters into a first plurality of phase-shifted RF signals; and receiving a second RF input signal. The method further includes phase shifting the second RF input signal by a second plurality of phase shifters into a second plurality of phase-shifted RF signals; combining a first phase-shifted RF signal from the first plurality of phase-shifted RF signals with a first phase-shifted RF signal from the second plurality of phase-shifted RF signals into a first RF output signal; and combining a second phase-shifted RF signal from the first plurality of phase-shifted RF signals with a second phase-shifted RF signal from the second plurality of phase-shifted RF signals into a second RF output signal. The first and second pluralities of phase shifters are arranged in a two-dimensional (2-D) array on a semiconductor die, and wherein the semiconductor die includes a 2-D array of inductors electrically coupled to the 2-D array of the phase shifters.

In some embodiments, an apparatus includes a two-dimensional (2-D) array of electrical elements including a first plurality of the electrical elements and a second plurality of the electrical elements. The first plurality of the electrical elements is arranged in a first direction of the 2-D array of electrical elements, and the first plurality of the electrical elements is electrically coupled to a first radio frequency (RF) input. The second plurality of the electrical elements is arranged in a second direction of the 2-D array of electrical elements, and the second plurality of the electrical elements is electrically coupled to a first radio frequency (RF) output. The first and second directions intersect each other.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1A illustrates a schematic of an electrical configuration for a phased array antenna system in accordance with one embodiment of the present disclosure including an antenna lattice defining an antenna aperture, mapping, a beamformer lattice, a multiplex feed network, a distributor or combiner, and a modulator or demodulator.

FIG. 1B illustrates a signal radiation pattern achieved by a phased array antenna aperture in accordance with one embodiment of the present disclosure.

FIG. 1C illustrates schematic layouts of individual antenna elements of phased array antennas to define various antenna apertures in accordance with embodiments of the present disclosure (e.g., rectangular, circular, space tapered).

FIG. 1D illustrates individual antenna elements in a space tapered configuration to define an antenna aperture in accordance with embodiments of the present disclosure.

FIG. 1E is a cross-sectional view of a panel defining the antenna aperture in FIG. 1D.

FIG. 1F is a graph of a main lobe and undesirable side lobes of an antenna signal.

FIG. 1G illustrates an isometric view of a plurality of stack-up layers which make up a phased array antenna system in accordance with one embodiment of the present disclosure.

FIG. 2 is a block diagram of the phased array antenna in accordance with an embodiment of the present disclosure.

FIG. 3 is a detail view of a portion of the phased array antenna of FIG. 2 according to embodiments of the present disclosure.

FIG. 4 is a schematic layout of a receiver in accordance with an embodiment of the present disclosure.

FIGS. 4A-4L are schematic illustrations of Input/Output terminations in accordance with embodiments of the present disclosure.

FIGS. 5A and 5B are schematic illustrations of equivalent circuits in accordance with embodiments of the present disclosure.

FIG. 6A is a top plan view of a semiconductor die in accordance with an embodiment of the present disclosure.

FIG. 6B is a detail view of a portion of the semiconductor die of FIG. 6A in accordance with an embodiment of the present disclosure.

FIGS. 7A-7C are schematic views of alternative inductor configurations in accordance with embodiments of the present disclosure.

FIG. 8 illustrates an alternative implementation of the phase shifter electrically coupled to the inductor in a distributed phase shifter array in accordance with embodiments of the present disclosure.

FIG. 9 is a graph of S-parameters as a function of frequency in accordance with an embodiment of the present disclosure.

FIG. 10 shows an alternative embodiment of a distributed array in accordance with embodiments of the present disclosure.

### DETAILED DESCRIPTION

Embodiments of apparatuses and methods related to distributed phase shifting are described herein. In embodiments, an apparatus includes a two-dimensional (2-D) array of phase shifters including a first plurality of the phase shifters and a second plurality of the phase shifters. The first plurality of the phase shifters is arranged in a first direction of the 2-D array of phase shifters, and the first plurality of the phase shifters is electrically coupled to a first radio frequency (RF) input. The second plurality of the phase shifters is arranged in a second direction of the 2-D array of phase shifters, and the second plurality of the phase shifters is electrically coupled to a first radio frequency (RF) output. The first and second directions intersect each other. These and other aspects of the present disclosure will be more fully described below.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “top surface”, “bottom surface”, “vertical”, “horizontal”, and “lateral” in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

Many embodiments of the technology described herein may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

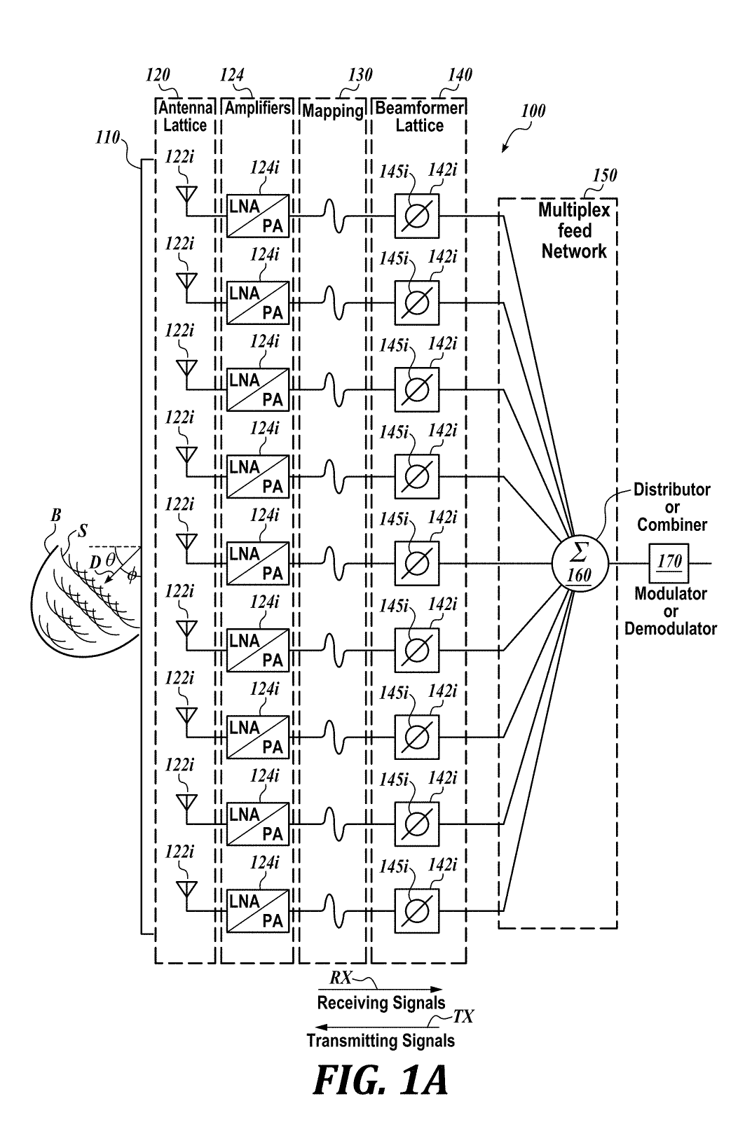

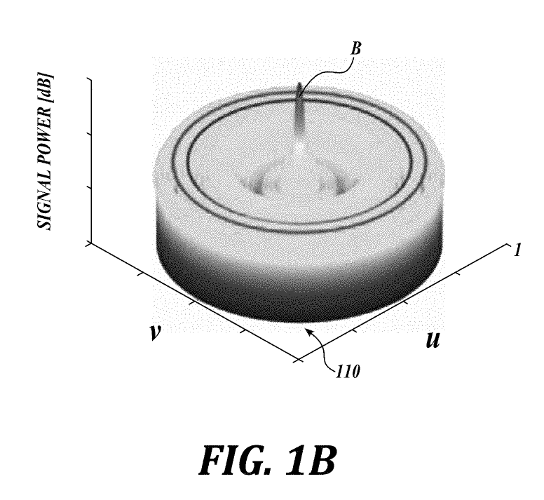

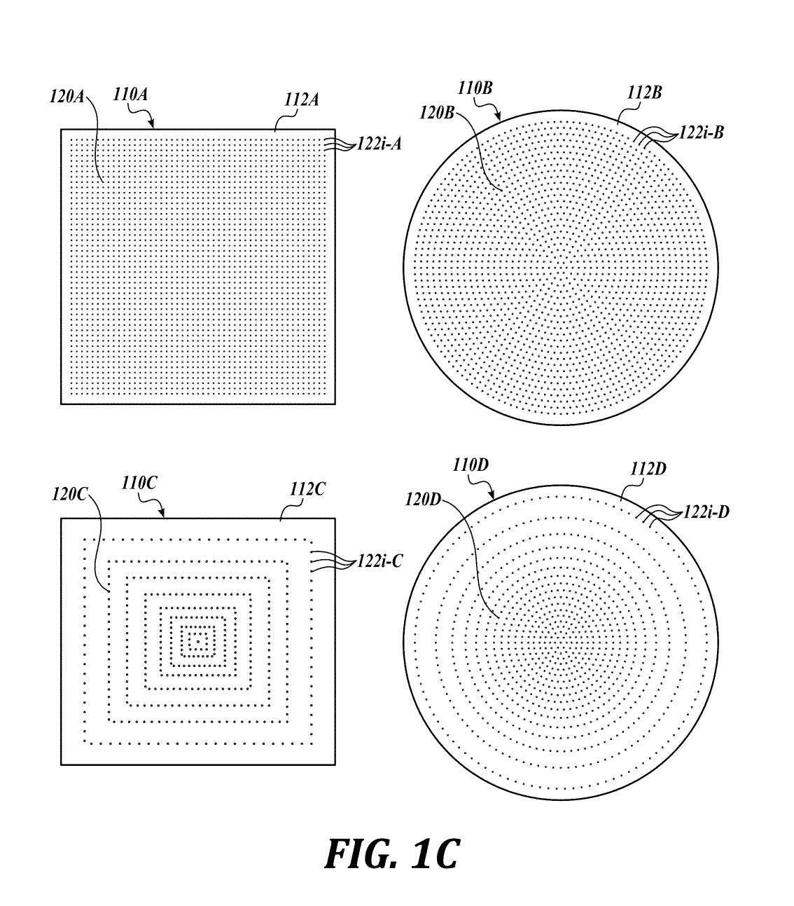

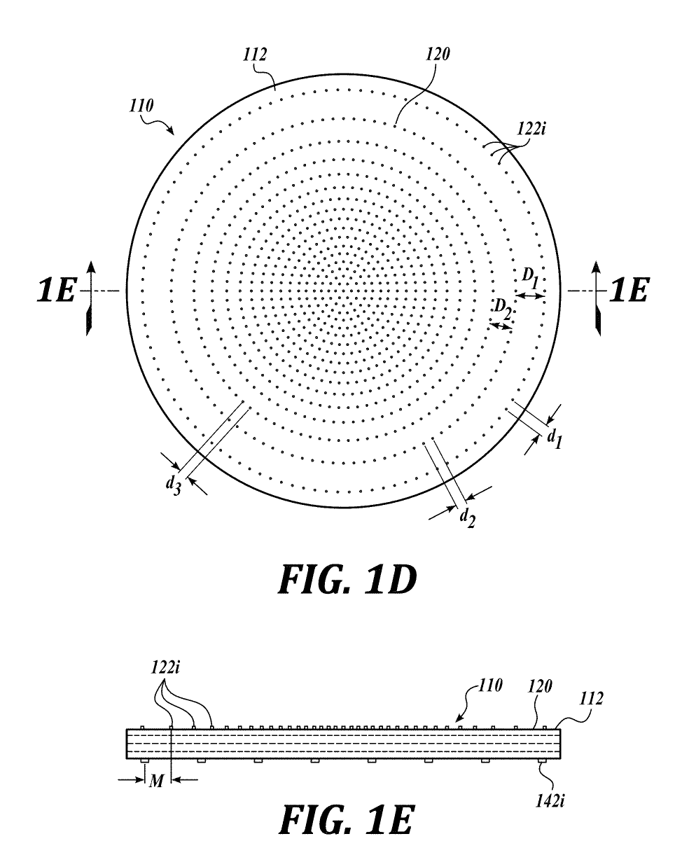

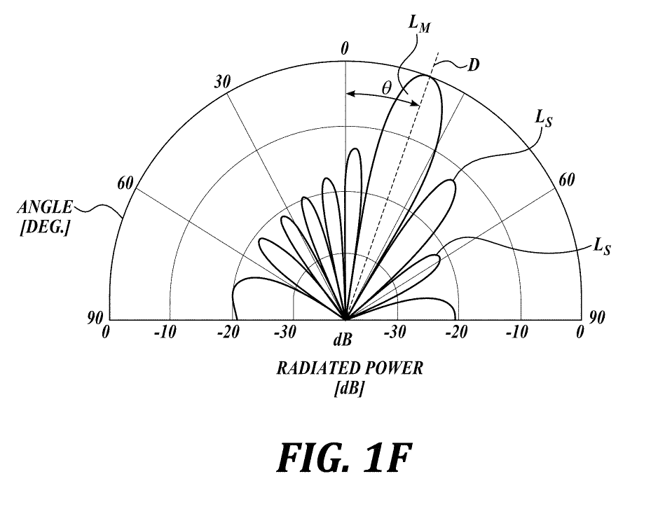

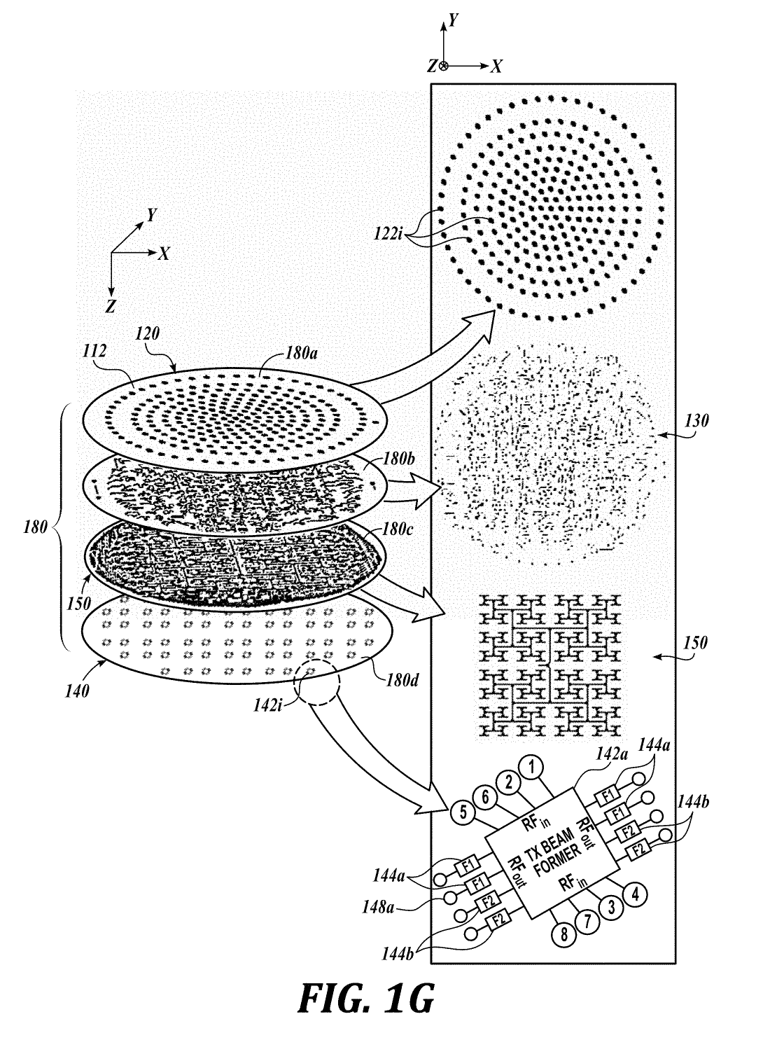

FIG. 1A is a schematic illustration of a phased array antenna system 100 in accordance with embodiments of the present disclosure. The phased array antenna system 100 is designed and configured to transmit or receive a combined beam B composed of signals S (also referred to as electromagnetic signals, wavefronts, or the like) in a preferred direction D from or to an antenna aperture 110. (Also see the combined beam B and antenna aperture 110 in FIG. 1B). The direction D of the beam B may be normal to the antenna aperture 110 or at an angle 0 from normal.

Referring to FIG. 1A, the illustrated phased array antenna system 100 includes an antenna lattice 120, a mapping system 130, a beamformer lattice 140, a multiplex feed network 150 (or a hierarchical network or an H-network), a combiner or distributor 160 (a combiner for receiving signals or a distributor for transmitting signals), and a modulator or demodulator 170. The antenna lattice 120 is configured to transmit or receive a combined beam B of radio frequency signals S having a radiation pattern from or to the antenna aperture 110.

In accordance with embodiments of the present disclosure, the phased array antenna system 100 may be a multi-beam phased array antenna system, in which each beam of the multiple beams may be configured to be at different angles, different frequency, and/or different polarization.

In the illustrated embodiment, the antenna lattice 120 includes a plurality of antenna elements 122i. A corresponding plurality of amplifiers 124i are coupled to the plurality of antenna elements 122i. The amplifiers 124i may be low noise amplifiers (LNAs) in the receiving direction RX or power amplifiers (PAs) in the transmitting direction TX. The plurality of amplifiers 124i may be combined with the plurality of antenna elements 122i in for example, an antenna module or antenna package. In some embodiments, the plurality of amplifiers 124i may be located in another lattice separate from the antenna lattice 120.

Multiple antenna elements 122i in the antenna lattice 120 are configured for transmitting signals (see the direction of arrow TX in FIG. 1A for transmitting signals) or for receiving signals (see the direction of arrow RX in FIG. 1A for receiving signals). Referring to FIG. 1B, the antenna aperture 110 of the phased array antenna system 100 is the area through which the power is radiated or received. In accordance with one embodiment of the present disclosure, an exemplary phased array antenna radiation pattern from a phased array antenna system 100 in the u/v plane is provided in FIG. 1B. The antenna aperture has desired pointing angle D and an optimized beam B, for example, reduced side lobes Ls to optimize the power budget available to the main lobe Lm or to meet regulatory criteria for interference, as per regulations issued from organizations such as the Federal Communications Commission (FCC) or the International Telecommunication Union (ITU). (See FIG. 1F for a description of side lobes Ls and the main lobe Lm.)

Referring to FIG. 1C, in some embodiments (see embodiments 120A, 120B, 120C, 120D), the antenna lattice 120 defining the antenna aperture 110 may include the plurality of antenna elements 122i arranged in a particular configuration on a printed circuit board (PCB), ceramic, plastic, glass, or other suitable substrate, base, carrier, panel, or the like (described herein as a carrier 112). The plurality of antenna elements 122i, for example, may be arranged in concentric circles, in a circular arrangement, in columns and rows in a rectilinear arrangement, in a radial arrangement, in equal or uniform spacing between each other, in non-uniform spacing between each other, or in any other arrangement. Various example arrangements of the plurality of antenna elements 122i in antenna lattices 120 defining antenna apertures (110A, 110B, 110C, and 110D) are shown, without limitation, on respective carriers 112A, 112B, 112C, and 112D in FIG. 1C.

The beamformer lattice 140 includes a plurality of beamformers 142i including a plurality of phase shifters 145i. In the receiving direction RX, the beamformer function is to delay the signals arriving from each antenna element so the signals all arrive to the combining network at the same time. In the transmitting direction TX, the beamformer function is to delay the signal sent to each antenna element such that all signals arrive at the target location at the same time. This delay can be accomplished by using “true time delay” or a phase shift at a specific frequency.

Following the transmitting direction of arrow TX in the schematic illustration of FIG. 1A, in a transmitting phased array antenna system 100, the outgoing radio frequency (RF) signals are routed from the modulator 170 via the distributer 160 to a plurality of individual phase shifters 145i in the beamformer lattice 140. The RF signals are phase-offset by the phase shifters 145i by different phases, which vary by a predetermined amount from one phase shifter to another. Each frequency needs to be phased by a specific amount in order to maintain the beam performance. If the phase shift applied to different frequencies follows a linear behavior, the phase shift is referred to as “true time delay”. Common phase shifters, however, apply a constant phase offset for all frequencies.

For example, the phases of the common RF signal can be shifted by 0° at the bottom phase shifter 145i in FIG. 1A, by Δα at the next phase shifter 145i in the column, by 2Δα at the next phase shifter, and so on. As a result, the RF signals that arrive at amplifiers 124i (when transmitting, the amplifiers are power amplifiers “PAs”) are respectively phase-offset from each other. The PAs 124i amplify these phase-offset RF signals, and antenna elements 122i emit the RF signals S as electromagnetic waves.

Because of the phase offsets, the RF signals from individual antenna elements 122i are combined into outgoing wave fronts that are inclined at angle ϕ from the antenna aperture 110 formed by the lattice of antenna elements 122i. The angle ϕ is called an angle of arrival (AoA) or a beamforming angle. Therefore, the choice of the phase offset Act determines the radiation pattern of the combined signals S defining the wave front. In FIG. 1B, an exemplary phased array antenna radiation pattern of signals S from an antenna aperture 110 in accordance with one embodiment of the present disclosure is provided.

Following the receiving direction of arrow RX in the schematic illustration of FIG. 1A, in a receiving phased array antenna system 100, the signals S defining the wave front are detected by individual antenna elements 122i, and amplified by amplifiers 124i (when receiving signals the amplifiers are low noise amplifiers “LNAs”). For any non-zero AoA, signals S comprising the same wave front reach the different antenna elements 122i at different times. Therefore, the received signal will generally include phase offsets from one antenna element of the receiving (RX) antenna element to another. Analogously to the emitting phased array antenna case, these phase offsets can be adjusted by phase shifters 145i in the beamformer lattice 140. For example, each phase shifter 145i (e.g., a phase shifter chip) can be programmed to adjust the phase of the signal to the same reference, such that the phase offset among the individual antenna elements 122i is canceled in order to combine the RF signals corresponding to the same wave front. As a result of this constructive combining of signals, a higher signal to noise ratio (SNR) can be attained on the received signal, which results in increased channel capacity.

Still referring to FIG. 1A, a mapping system 130 may be disposed between the antenna lattice 120 and the beamformer lattice 140 to provide length matching for equidistant electrical connections between each antenna element 122i of the antenna lattice 120 and the phase shifters 145i in the beamformer lattice 140, as will be described in greater detail below. A multiplex feed or hierarchical network 150 may be disposed between the beamformer lattice 140 and the distributor/combiner 160 to distribute a common RF signal to the phase shifters 145i of the beamformer lattice 140 for respective appropriate phase shifting and to be provided to the antenna elements 122i for transmission, and to combine RF signals received by the antenna elements 122i, after appropriate phase adjustment by the beamformers 142i.

In accordance with some embodiments of the present disclosure, the antenna elements 122i and other components of the phased array antenna system 100 may be contained in an antenna module to be carried by the carrier 112.

Referring to FIGS. 1D and 1E, an exemplary configuration for an antenna aperture 120 in accordance with one embodiment of the present disclosure is provided. In the illustrated embodiment of FIGS. 1D and 1E, the plurality of antenna elements 122i in the antenna lattice 120 are distributed with a space taper configuration on the carrier 112. In accordance with a space taper configuration, the number of antenna elements 122i changes in their distribution from a center point of the carrier 112 to a peripheral point of the carrier 112. For example, compare spacing between adjacent antenna elements 122i, D1 to D2, and compare spacing between adjacent antenna elements 122i, d1, d2, and d3. Although shown as being distributed with a space taper configuration, other configurations for the antenna lattice are also within the scope of the present disclosure.

The system 100 includes a first portion carrying the antenna lattice 120 and a second portion carrying a beamformer lattice 140 including a plurality of beamformer elements. As seen in the cross-sectional view of FIG. 1E, multiple layers of the carrier 112 carry electrical and electromagnetic connections between elements of the phased array antenna system 100. In the illustrated embodiment, the antenna elements 122i are located the top surface of the top layer and the beamformer elements 142i are located on the bottom surface of the bottom layer. While the antenna elements 122i may be configured in a first arrangement, such as a space taper arrangement, the beamformer elements 142i may be arranged in a second arrangement different from the antenna element arrangement. For example, the number of antenna elements 122i may be greater than the number of beamformer elements 142i, such that multiple antenna elements 122i correspond to one beamformer element 142i. As another example, the beamformer elements 142i may be laterally displaced from the antenna elements 122i on the carrier 112, as indicated by distance M in FIG. 1E. In one embodiment of the present disclosure, the beamformer elements 142i may be arranged in an evenly spaced or organized arrangement, for example, corresponding to an H-network, or a cluster network, or an unevenly spaced network such as a space tapered network different from the antenna lattice 120. In some embodiments, one or more additional layers may be disposed between the top and bottom layers of the carrier 112. Each of the layers may comprise one or more PCB layers.

Referring to FIG. 1F, a graph of a main lobe Lm and side lobes Ls of an antenna signal in accordance with embodiments of the present disclosure is provided. The horizontal (also the radial) axis shows radiated power in dB. The angular axis shows the angle of the RF field in degrees. The main lobe Lm represents the strongest RF field that is generated in a preferred direction by a phased array antenna system 100. In the illustrated case, a desired pointing angle D of the main lobe Lm corresponds to about 20°. Typically, the main lobe Lm is accompanied by a number of side lobes Ls. However, side lobes Ls are generally undesirable because they derive their power from the same power budget thereby reducing the available power for the main lobe Lm. Furthermore, in some instances the side lobes Ls may reduce the SNR of the antenna aperture 110. Also, side lobe reduction is important for regulation compliance.

One approach for reducing side lobes Ls is arranging elements 122i in the antenna lattice 120 with the antenna elements 122i being phase offset such that the phased array antenna system 100 emits a waveform in a preferred direction D with reduced side lobes. Another approach for reducing side lobes Ls is power tapering. However, power tapering is generally undesirable because by reducing the power of the side lobe Ls, the system has increased design complexity of requiring of “tunable and/or lower output” power amplifiers. In addition, a tunable amplifier 124i for output power has reduced efficiency compared to a non-tunable amplifier. Alternatively, designing different amplifiers having different gains increases the overall design complexity and cost of the system.

Yet another approach for reducing side lobes Ls in accordance with embodiments of the present disclosure is a space tapered configuration for the antenna elements 122i of the antenna lattice 120. (See the antenna element 122i configuration in FIGS. 1C and 1D.) Space tapering may be used to reduce the need for distributing power among antenna elements 122i to reduce undesirable side lobes Ls. However, in some embodiments of the present disclosure, space taper distributed antenna elements 122i may further include power or phase distribution for improved performance.

In addition to undesirable side lobe reduction, space tapering may also be used in accordance with embodiments of the present disclosure to reduce the number of antenna elements 122i in a phased array antenna system 100 while still achieving an acceptable beam B from the phased array antenna system 100 depending on the application of the system 100. (For example, compare in FIG. 1C the number of space-tapered antenna elements 122i on carrier 112D with the number of non-space tapered antenna elements 122i carried by carrier 112B.)

FIG. 1G depicts an exemplary configuration of the phased array antenna system 100 implemented as a plurality of PCB layers in lay-up 180 in accordance with embodiments of the present disclosure. The plurality of PCB layers in lay-up 180 may comprise a PCB layer stack including an antenna layer 180a, a mapping layer 180b, a multiplex feed network layer 180c, and a beamformer layer 180d. In the illustrated embodiment, mapping layer 180b is disposed between the antenna layer 180a and multiplex feed network layer 180c, and the multiplex feed network layer 180c is disposed between the mapping layer 180b and the beamformer layer 180d.

Although not shown, one or more additional layers may be disposed between layers 180a and 180b, between layers 180b and 180c, between layers 180c and 180d, above layer 180a, and/or below layer 180d. Each of the layers 180a, 180b, 180c, and 180d may comprise one or more PCB sub-layers. In other embodiments, the order of the layers 180a, 180b, 180c, and 180d relative to each other may differ from the arrangement shown in FIG. 1G. For instance, in other embodiments, beamformer layer 180d may be disposed between the mapping layer 180b and multiplex feed network layer 180c.

Layers 180a, 180b, 180c, and 180d may include electrically conductive traces (such as metal traces that are mutually separated by electrically isolating polymer or ceramic), electrical components, mechanical components, optical components, wireless components, electrical coupling structures, electrical grounding structures, and/or other structures configured to facilitate functionalities associated with the phase array antenna system 100. Structures located on a particular layer, such as layer 180a, may be electrically interconnected with vertical vias (e.g., vias extending along the z-direction of a Cartesian coordinate system) to establish electrical connection with particular structures located on another layer, such as layer 180d.

Antenna layer 180a may include, without limitation, the plurality of antenna elements 122i arranged in a particular arrangement (e.g., a space taper arrangement) as an antenna lattice 120 on the carrier 112. Antenna layer 180a may also include one or more other components, such as corresponding amplifiers 124i. Alternatively, corresponding amplifiers 124i may be configured on a separate layer. Mapping layer 180b may include, without limitation, the mapping system 130 and associated carrier and electrical coupling structures. Multiplex feed network layer 180c may include, without limitation, the multiplex feed network 150 and associated carrier and electrical coupling structures. Beamformer layer 180d may include, without limitation, the plurality of phase shifters 145i, other components of the beamformer lattice 140, and associated carrier and electrical coupling structures. Beamformer layer 180d may also include, in some embodiments, modulator/demodulator 170 and/or coupler structures. In the illustrated embodiment of FIG. 1G, the beamformers 142i are shown in phantom lines because they extend from the underside of the beamformer layer 180d.

Although not shown, one or more of layers 180a, 180b, 180c, or 180d may itself comprise more than one layer. For example, mapping layer 180b may comprise two or more layers, which in combination may be configured to provide the routing functionality discussed above. As another example, multiplex feed network layer 180c may comprise two or more layers, depending upon the total number of multiplex feed networks included in the multiplex feed network 150.

In accordance with embodiments of the present disclosure, the phased array antenna system 100 may be a multi-beam phased array antenna system. In a multi-beam phased array antenna configuration, each beamformer 142i may be electrically coupled to more than one antenna element 122i. The total number of beamformer 142i may be smaller than the total number of antenna elements 122i. For example, each beamformer 142i may be electrically coupled to four antenna elements 122i or to eight antenna elements 122i.

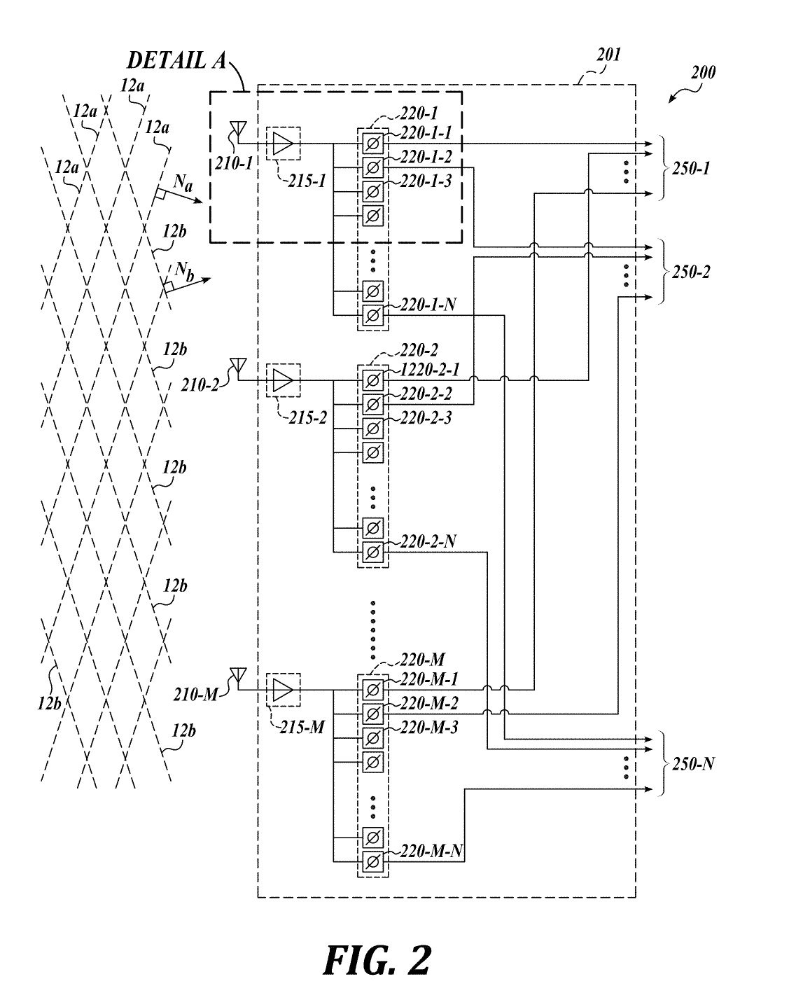

FIG. 2 depicts a block diagram of a phased array antenna system 200 in accordance with embodiments of the present disclosure. The phased array antenna system 200 may be configured to be a multi-beam phase array antenna system. In a receiver configuration, the phased array antenna system 200 includes antenna elements 210-1 to 210-M (e.g., similar to antenna elements 122i) that are connected to corresponding low noise amplifiers (LNAs) 215-1 to 215-M (e.g., similar to amplifiers 124i). The individual antenna elements, e.g., the antenna element 210-1, may receive multiple wavefronts 12a, 12b, etc. (also referred to as beams, radio frequency (RF) inputs, RF signals, or RF input signals), arriving at the antenna elements from different directions (denoted as Na, Nb, etc.) and/or at different times from each other. As a non-limiting example, wavefronts 12a, 12b, etc. may be associated with a frequency of approximately 5-15 Gigahertz (GHz).

After the LNAs 215-1 to 215-M amplify the received RF signals, the signals from the individual antenna elements are phase-shifted by the phase shifters 220-1-1 to 220-M-N (e.g., similar to phase shifters 145i). For example, the RF signal from the antenna element 210-1 is phase-shifted by a bank of phase shifters 220-1, e.g., the phase shifters 220-1-1 to 220-1-N. Analogously, the banks of phase shifters 220-2 to 220-M shift the phase of the signals from the antenna elements 210-2 to 210-M, respectively.

In at least some embodiments, the phase shifts applied to the RF signals by the phase shifters 220-1-1 to 220-1-N can be selected to correspond to the phase offsets of one of the wavefronts 12a, 12b, etc., therefore cancelling the phase shifts caused by the non-zero AoA. The outputs of the phase shifters 220-1-1, 220-2-1, . . . , and 220-M-1 may be routed to an RF output 250-1. The RF outputs of the phase shifters 220-1-1, 220-2-1, . . . , 220-M-1 may collectively correspond to the wavefront 12a since the phase shifters have already applied appropriate phase shifts to the RF input signals of the wavefront 12a. As another example, the outputs of the phase shifters 220-1-2, 220-2-2, . . . , and 220-M-2 may be routed to an RF output 250-2, collectively corresponding to the wavefront 12b, and so on. In some embodiments, the phase shifters can be vector modulator phase shifters (e.g., magnitude/phase (I/Q) variable gain amplifiers (VGAs)).

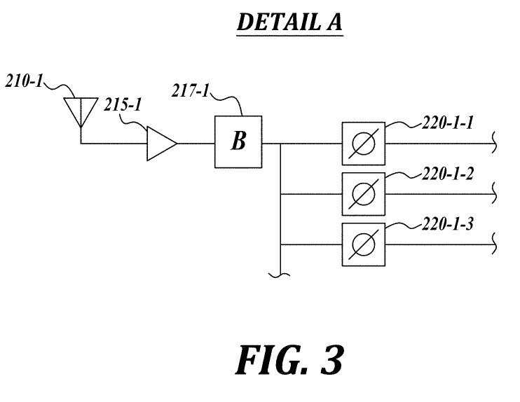

The outputs 250-1 to 250-N may then be routed to corresponding demodulators, analog/digital (A/D) convertors, and/or other parts of the receiver for further processing. System 200 may also include one or more additional components, such as shown in a detail view of a phased array antenna in FIG. 3. In FIG. 3, in some embodiments, signals from the individual LNAs 215 may be routed through a buffer (e.g., a buffer 217-1) and then to the phase shifters 220-i. In some embodiments, the buffer 217-1 may provide impedance isolation and/or transformation. The portion of the system 200 from the inputs of the LNAs 215-1 to 215-M to the outputs of the phase shifters 220-1-1 to 220-M-N may be referred to as a receiver 201.

It is contemplated that phased array antenna system 200 may also operate as a transmitter (or a part of a transmitter) by preparing/processing signals in the reverse order from that discussed above in connection with receiving and processing wavefronts 12a, 12b, etc., for multiple beams to be emitted by the antenna elements 210-1 to 210-M. In the transmitter configuration, LNAs 215-1 to 215-M may be replaced with power amplifiers (PAs).

In some embodiments, phased array antenna system 200 may comprise a multi-beam implementation of the phase array antenna system 100 of FIG. 1A. For example, without limitation, antenna elements 210-1 to 210-M and LNAs 215-1 to 215-M may be included in the antenna lattice 120 of FIG. 1A and phase shifters 220-1-1 to 220-M-N may be included in the beamformer lattice 140 of FIG. 1A.

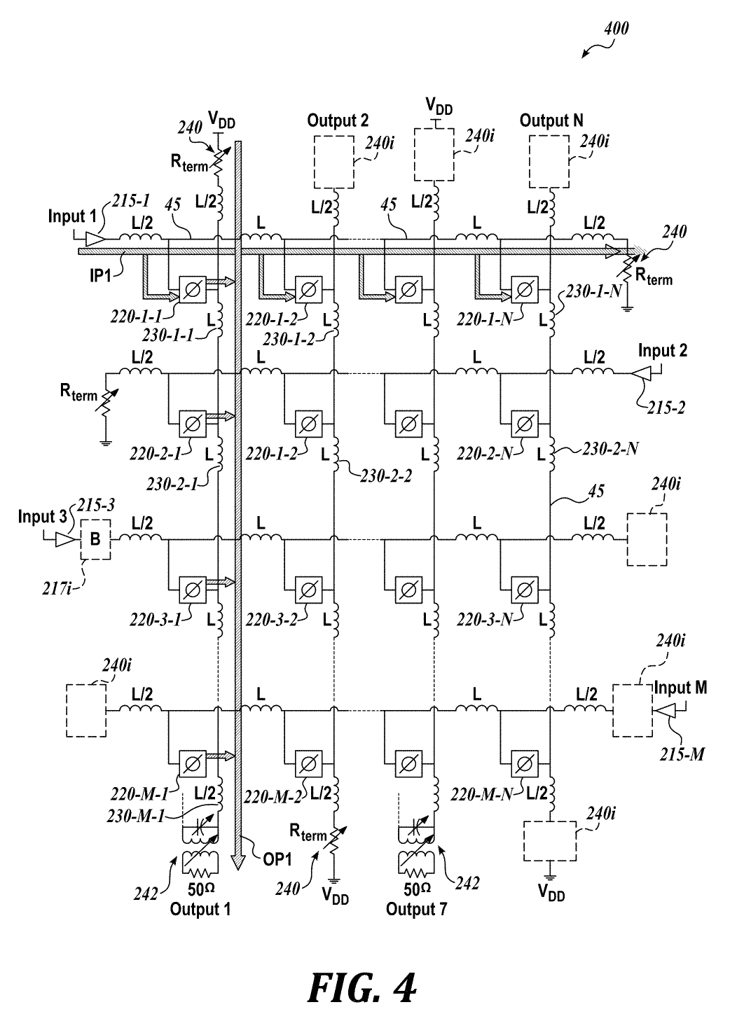

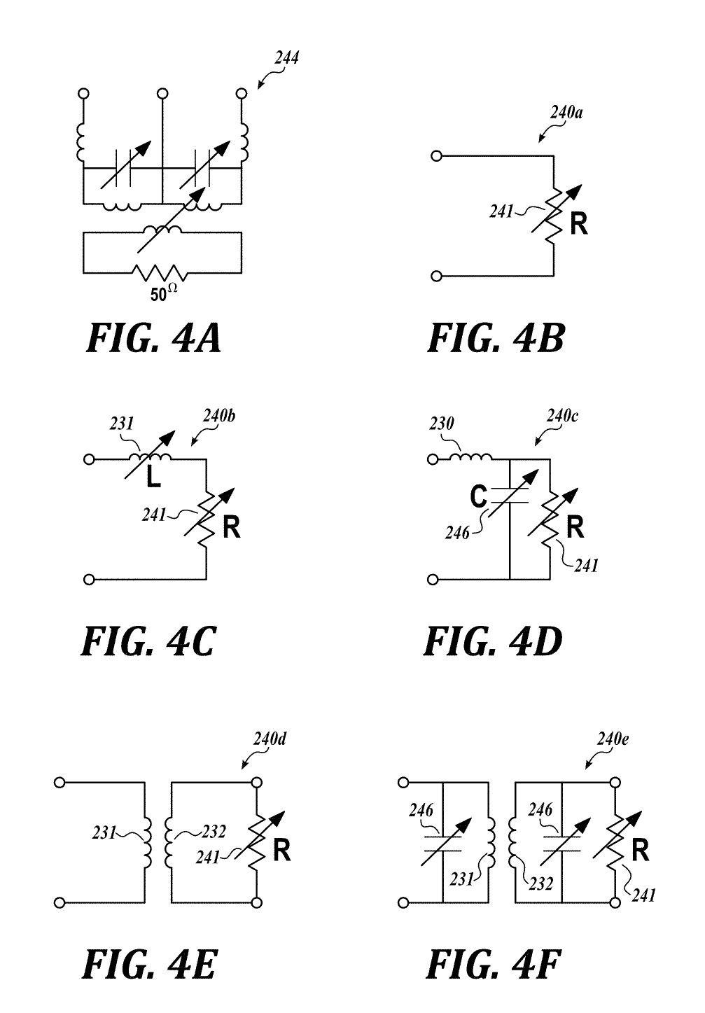

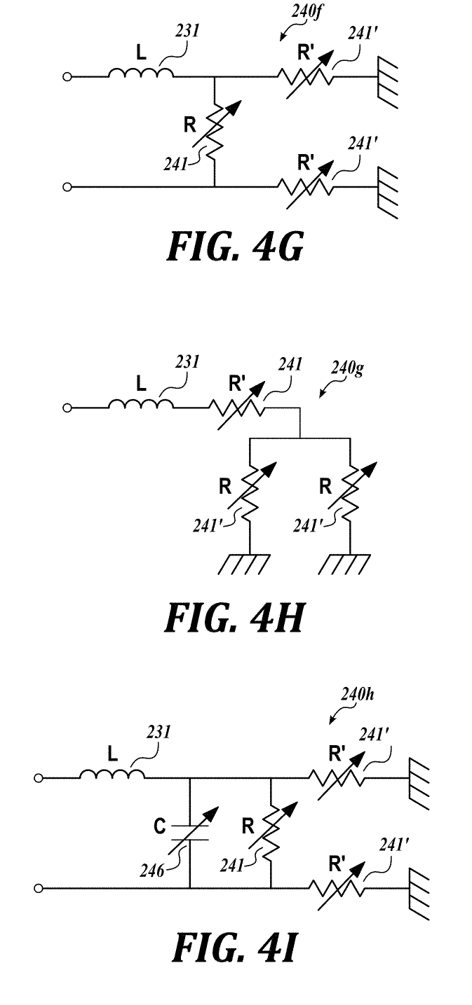

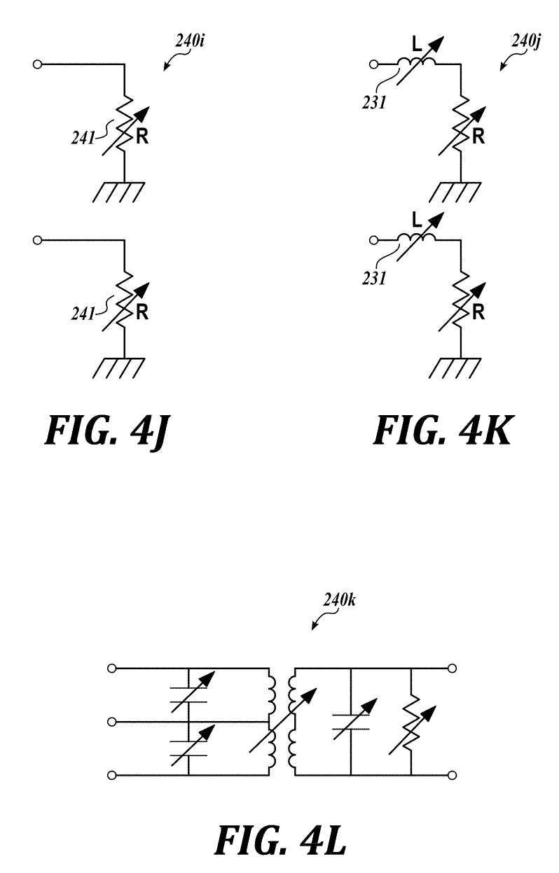

Multiple LNAs and/or phase shifters of the phased array antenna system 200 may be implemented in a discrete integrated circuit (IC) chip (e.g., a semiconductor die). Receiver 201 (including LNAs 215-1 to 215-M and phase shifters 220-1-1 to 220-M-N) packaged as a single, discrete IC chip 400 is shown in FIG. 4 in accordance with embodiments of the present disclosure. Antenna elements 210 may be excluded from IC chip 400 and provided on one or more different chips/semiconductor dies or as separate components. FIG. 4 is a schematic layout of the receiver 201 in accordance with an embodiment of the present disclosure. In other embodiments, the IC chip 400 can operate as a transmitter (or as a part of a transmitter) by preparing signals to be emitted by the phased array antenna system (e.g., reversing the signal processing order from that discussed below and using PAs instead of LNAs). The illustrated embodiment of the IC chip 400 includes the LNAs 215-1 to 215-M, but alternative embodiments excluding the LNAs are also within the scope of the present disclosure. Embodiments of IC chip 400 including phase shifters and excluding LNAs may comprise a beamformer. In still other alternative embodiments, LNAs and/or phase shifters of the phased array antenna system 200 may be implemented in more than one IC chip or semiconductor die.

In some embodiments, IC chip 400 includes a plurality of the phase shifters 220-1-1 to 220-M-N. Because the phase shifters are built on a common IC chip, the size, cost, and power consumption of the receiver may be reduced. The phase shifters 220-1-1 to 220-M-N can be arranged in a 2-D array (e.g., an M×N array), where the rows correspond to the inputs (Input 1 to Input M) from the individual antenna elements and/or LNAs, and the columns correspond to the outputs of the phase shifters (Output 1 to Output N) (e.g., outputs 250-1 to 250-N in FIG. 2). In some embodiments, M and N can be 4, 8, 10, 16, 24, or more, and M and N may be the same or different values from each other.

The phase shifters may be configured to receive single ended or differential RF signals. The outputs can further be connected to respective demodulators, A/D converters, and/or other parts of the phased array antenna circuitry that may be part of the same IC chip 400 or may be built on separate chips. A horizontal line IP1 represents a path of the RF input signal Input 1, and a vertical line OP1 represents a path of the output signal Output 1. In other embodiments, the rows and columns may be arranged such that the inputs are in the columns, and the outputs are in the rows by, e.g., rotating the IC chip 400 by 90°.

In some embodiments, the individual RF inputs Input 1 to Input M may be phase shifted in accordance with the scheme illustrated in FIG. 2. For example, Input 1 (IP1) can be routed from an individual antenna element or LNA to each of the phase shifters 220-1-1 to 220-1-N; each of the phase shifters 220-1-1 to 220-1-N respectively phase shifting the received signal by a pre-determined amount; and then the phase-shifted signals may be distributed to the outputs Output 1-Output N. In some embodiments, the phase shifter 220-1-1 may phase-shift by a first phase shifting amount and route RF signal Input 1 (IP1) to Output 1 (OP1), the phase shifter 220-1-2 may phase-shift by a second phase shifting amount and route the same IP1 to Output 2, and so on. The first and second phase shifting amounts may be different from each other.

Analogously, the RF signal of Input 2 may be phase-shifted by the phase shifters 220-2-1 to 220-2-N and routed to the corresponding outputs Output 1-Output N, and so on with Input 3 to Input M. In at least some embodiments, the phase shifts of the individual phase shifters are selected such as to coherently combine the wavefronts 12a, 12b, etc., at the individual outputs (e.g., Output 1 corresponding to the wavefront 12a, Output 2 corresponding to the wavefront 12b, etc.). The phase shifts can be calculated to coherently combine the signals from the antenna elements for a wavefront that has an AoA ϕ. In some embodiments, N outputs may be configured for N wavefronts or beams to be received or transmitted by the phased array antenna system 200/IP chip 400.

In some embodiments, the parasitic capacitance that is naturally present in the phase shifters and/or among the traces (also referred to as conductive traces, interconnect lines, interconnect traces, and the like) may cause a relatively low cutoff frequency (e.g., a relatively narrow frequency bandwidth) for the RF signals in the IC chip 400. Therefore, a set of discrete inductors may be included in the IC chip 400 to improve the bandwidth of the RF signals. On-the-chip inductors 230-1-1 to 230-M-N can be manufactured as discrete inductors in conjunction with manufacturing the rest of the IC chip 400. In other embodiments, the naturally occurring inductances of traces 45 (e.g., metal/conductive traces in the IC chip 400, individual trace in the IC chip 400, pairs of metal traces in the IC chip 400, positive/negative differential lines that are metal traces, metal traces and ground lines or planes, etc.) can be used to offset or absorb the parasitic capacitances. For example, the inductance associated with the traces 45 may be tuned by changing its width or shape (e.g., narrowing of the trace width may increase its inductance). In some embodiments, the inductances of the discrete inductors 230 or the traces 45 may be different at different locations of the IC chip 400. The inductances of the discrete inductors 230 and the traces 45 are respectively denoted as L and L/2 in FIG. 4.

Generally, phase shifting in one phase shifter should not affect phase shifting in the neighboring phase shifter to avoid “beam pulling,” or, stated differently, the isolation between phase shifters should be sufficiently high. To do so, the traces 45 can be placed and routed at optimal distances to reduce electromagnetic coupling. Other techniques may be used to tune traces and/or coupling between them. For example, BFMOAT (blocking) layers, isolation trenches, and/or varying conductivity of substrate-on-chip can be used to optimize coupling among the traces.

The parasitic capacitance C of an individual phase shifter can be absorbed by placing one or more discrete inductors 230 or the traces 45 having the required inductance at the phase shifters input and/or output. A combination of the capacitance and inductance can be modeled as a T-model pseudo transmission line. An approximate impedance of such a transmission line can be modeled as:

$$Z = \sqrt{\frac{L}{C} [ 1 - {( \frac{ω}{{ω}_{c}} )}^{2} ]}$$

where ω_{c}=2/\sqrt{LC} is the cutoff frequency, assuming a lossless lumped transmission line. Other models for transmission line impedance are within the scope of the present disclosure, for example a π model or a model based on m-derived sections. In some embodiments, the transmission of the RF signals within the chip 400 may be considered wideband as long as the frequency of the RF signals is below the cutoff frequency corresponding to ω_{c.}

The pseudo-transmission lines implemented on the array may cause a phase delay that is a function of the equivalent L and parasitic C. This phase delay can be compensated for by the phase shifters 220, by adding/subtracting the additional phase delay to/from the required phase shift nominally associated with a phase shifter, in order to coherently combine the received signals at the outputs.

Depending on the quality factor (Q) of the discrete inductors/inductor lines and the frequency of the signals, some signal loss may be introduced in the array due to resistive loss, substrate loss, eddy currents, and/or skin and proximity effects. To compensate for these losses, the signals can be amplified accordingly. For example, at least some losses can be compensated using gain tuning capabilities of the phase shifters 220. In some embodiments, the gain tuning of a phase shifter may be implemented by, for example, back biasing a variable gain amplifier (VGA) I/Q vector modulator phase shifter. In other embodiments, the losses can be managed by adding attenuators to the array (not shown).

In this manner, inputs that are RF signals may be split along rows and combined (after appropriate processing such as phase shifting) in columns in a distributed architecture implemented in a compact planar area. Length matching of traces or other techniques that increase the space needed may be avoided without a reduction in signal quality or operating parameters.

In some embodiments, terminations of the Inputs 1-M and Outputs 1-N may include termination components, as shown in FIGS. 4 and 4A-4L. Examples of termination components may include, without limitation, terminating resistors 240, terminating transformers 242, terminations 240i, and the like. Output 1, for instance, may include a terminating resistor 240 at one end and a terminating transformer 242 at the opposite end. Terminating resistor 240 may comprise a variable resistor. Terminating transformer 242 may comprise a single ended transformer used in a single ended distributed array (such as shown in FIG. 4) and configured to provide impedance transformation and/or impedance matching (or at least improve impedance transformation and/or impedance matching). Impedance matching may be improved/matched with the different impedances associated with the lines, therefore reducing the intensity of the reflected RF waves in the IC chip 400.

If the distributed array of FIG. 4 is configured with differential outputs, continuing the above example of the terminations associated with Output 1, terminating transformer 242 may be replaced with a balun transformer 244 as shown in FIG. 4A. Balun transformer 244 may be configured to provide a differential to single ended conversion (e.g., convert a differential line to a signal ended line) and also to provide impedance transformation and/or impedance matching (or at least improve impedance transformation and/or impedance matching).

Balun transformer 244 may additionally or alternatively be located at the inputs. For example, the input may be single-ended and transformed into a differential line before the LNA 215, or after the LNA 215 and before the array of the phase shifters 230-i-j. The input balun transformer 244 may also transform the input impedance.

The termination of the Inputs 1-M and/or Outputs 1-N can take different forms. For example, the termination may be single-ended (common mode) or differential. Examples of terminations 240i are discussed with reference to FIGS. 4A-4L below. In some embodiments, the buffer 217 may be used instead of the terminations 240i.

The termination of at least some of the Inputs 1-M and/or Outputs 1-N may include terminating resistors 240 (Rₜₑᵣₘ) that can be tunable resistors to improve the uniformity of the impedance of the traces in view of, for example, manufacturing tolerances of the traces 45 in the IC chip 400 and/or parasitic capacitances. In some embodiments, the tunable terminating resistors can be a bank of field emission transistors (FETs) or combination of digital to analog converters (DACs) and FETs. The tunable resistive terminations may introduce extra capacitance in the trace 45. Therefore, in some embodiments, the half cells (the L/2 blocks at the two ends of the lines) can be modified to have an inductance of L/2+L1 to absorb this extra capacitance, therefore keeping trace impedance at or close to its design value (Z). In some embodiments, the IC chip 400 may include capacitors for improved control of matching at the cutoff frequency. For example, tunable/variable capacitor(s) included in the terminating transformer 242 or balun transformer 244 may be used in conjunction with half cell (L/2) inductor blocks to counteract manufacturing variations and tolerances, resulting in a more precise tunable L/2±ΔL block. In at least some embodiments, the combination of tunable capacitors and L/2 inductor blocks therefore improves impedance matching at and around the cut off frequency. In some embodiments, the IC chip 400 includes digital control, memory and shift register blocks, and/or associated wirings to implement the control, programming, and calibration required for the phase shifter array. In addition, the IC chip 400 may include one or more integrated temperature sensors to enable temperature calibration. Other components such as radiation sensors may also be included in the IC chip 400.

FIGS. 4A-4L are schematic illustrations of Input/Output terminations 244 and 240a-240k in accordance with embodiments of the present technology. Various configurations of single ended or differential; combinations of resistors, capacitors, and/or inductors; (explicitly) grounded or not; and/or the like terminations are shown. FIG. 4A shows the balun transformer 244 as discussed above. FIG. 4B shows the termination 240a that includes a tunable resistor 241. FIG. 4C shows the termination 240b that includes a tunable inductor 231 in series with a tunable resistor 241. FIG. 4D shows the termination 240c that includes an inductor 230 in series with a tunable capacitor 246 in parallel with the tunable resistor 241.

In some embodiments, multiple capacitors/resistors may be included to achieve desired termination impedance. FIG. 4E shows the termination 240d that includes an inductively coupled pair of inductors 231/232 and the tunable resistor 241. FIG. 4F shows the termination 240e comprising the termination 240d with each side of the inductor pair including the tunable capacitor 246. In some embodiments, the capacitors/inductors may have different capacitance/inductance values from each other.

FIGS. 4G-4I and 4L show the respective terminations 240f-240h and 240k including combinations of inductors 231, resistors 241/241′, and capacitors 246. Terminations 240f-240h and 240k may be implemented as differential matching or as common mode matching, for example. In some embodiments, a conventional Tee/Pi common mode matching network may be used. FIGS. 4G-4I and 4J-4K show terminations 240f-240h and 240i-240j implemented in a grounded configuration.

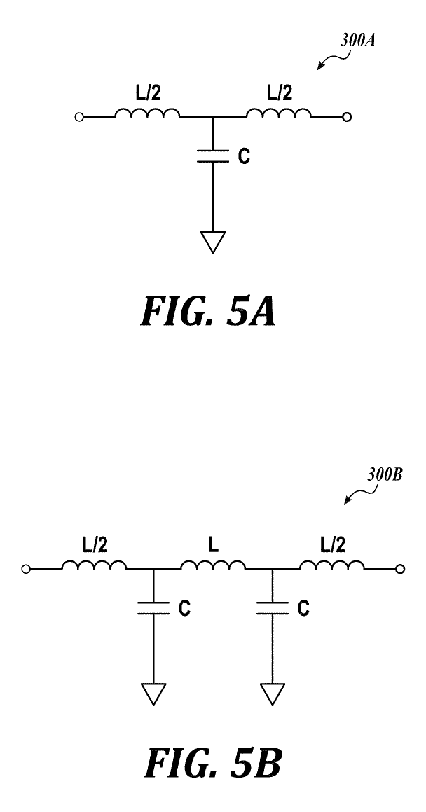

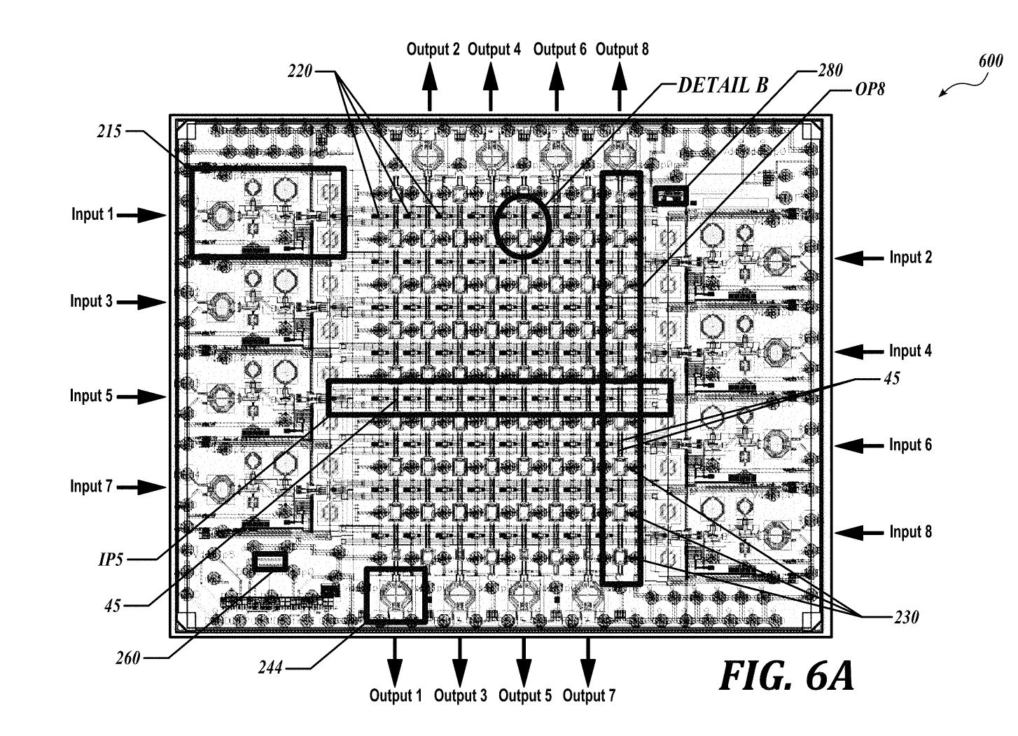

FIGS. 5A and 5B are schematic illustrations of transmission line models 300A and 300B in accordance with embodiments of the present technology. Transmission line models 300A and 300B may comprise equivalent circuit representations. In some embodiments, multiple blocks of such transmission line models 300A or 300B may be cascaded to represent a distributed pseudo-transmission line, e.g., the traces 45 of the IP1 or OP1 in FIG. 4. In some embodiments, two L/2 elements in series may be implemented separately or can be replaced by a single L equivalent element. In some embodiments, the inductance of the transmission line models 300A/300B can be tuned by changing the width of the trace 45 (e.g., narrowing of the trace 45 generally increases its inductance) or shape (e.g., making the trace 45 longer by introducing serpentine turns generally increases the inductance of the line).

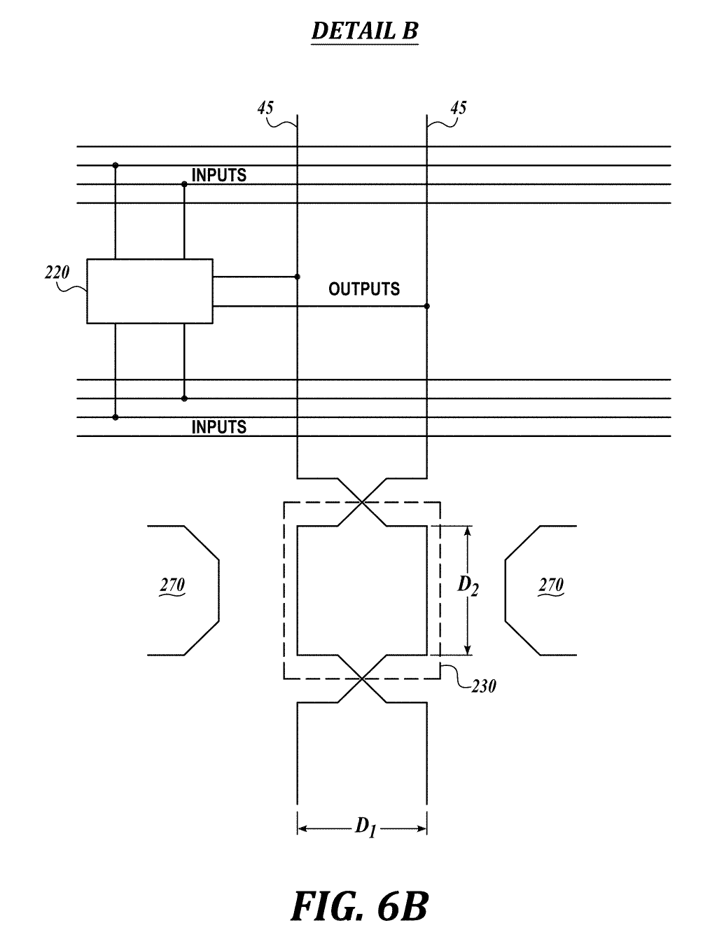

FIG. 6A is a top plan view of a semiconductor die 600 in accordance with an embodiment of the present technology. The illustrated semiconductor die 600 (e.g., an RF receiver) includes eight inputs (Input 1-Input 8) and eight outputs (Output 1-Output 8), but other numbers of inputs/outputs are also within the scope of the present disclosure. In at least some embodiments, the number of inputs may be different from the number of outputs. In some embodiments, the layout of the components included in the semiconductor die 600 may generally correspond to like components included in the IC chip 400 of FIG. 4. However, it is understood that different layouts may be within the scope of the present disclosure.

The individual RF inputs of the semiconductor die 600 are routed over LNAs 215, and further to a row of phase shifters 220. The inputs signals from the LNAs 215 are routed from the phase shifters 220 through the inductors 230 to the individual outputs Output 1-Output 8. For example, Output 8 may be a combination of the phase-shifted inputs routed over the components in OP8. An individual output combines the phase-shifted RF signals from multiple individual inputs (e.g., from each of inputs 1-8). In some embodiments, the inductance of the traces 45 can be used to provide the required inductance separately or in conjunction with the discrete inductors 230. The traces 45 can be single ended or differential lines. The individual outputs 1-8 may terminate with (tunable) balun transformers 244. In some embodiments, the semiconductor die 600 may include one or more digital blocks 260 (e.g., AD converters) and bandgap/bias blocks 280.

Inputs and Outputs in FIGS. 4 and 6A may be laid out in opposite signal traversal directions from each other in alternating rows (in the case of Inputs) or columns (in the case of Outputs) (also referred to as alternating opposite signal traversal directions). For example, Input 1 starts on the left side of IC chip 400/semiconductor die 600 and traverses to the right side of IC chip 400/semiconductor die 600, Input 2 starts on the right side of IC chip 400/semiconductor die 600 and traverses to the left side of IC chip 400/semiconductor die 600, and then Input 3 starts again on the left side of IC chip 400/semiconductor die 600 and traverses to the right side of IC chip 400/semiconductor die 600. Output 1 starts on the top side of IC chip 400/semiconductor die 600 and traverses to the bottom side of IC chip 400/semiconductor die 600, Output 2 starts on the bottom side of IC chip 400/semiconductor die 600 and traverses to the top side of IC chip 400/semiconductor die 600, and then Output 3 starts again on the top side of IC chip 400/semiconductor die 600 and traverses to the bottom side of IC chip 400/semiconductor die 600.

Such alternating opposing layout may reduce the overall amount of planar area needed for the distributed phase shift array and may keep the design compact, for example, in arrays in which the terminations of the Input and/or Output lines may comprise large components. Balun transformers 244 at terminations of Outputs 1-8, as shown in FIG. 6A, may be an example of large termination components that may not fit within the same layout area if all of the output lines are laid out in the same signal traversal direction to each other.

In alternative embodiments, the input lines may be oriented in the same signal traversal direction with each other and/or the output lines may be oriented in the same signal traversal direction with each other. In still other embodiments, fewer or more than half of the input lines or the output lines may be implemented in the alternating opposite direction configuration.

FIG. 6B is a detailed view of a portion of the semiconductor die 600 denoted as “Detail B” in FIG. 6A, in accordance with embodiments of the present disclosure. Such portion includes a phase shifter 220 electrically coupled to a discrete inductor 230 via a pair of traces 45. The discrete inductor 230 may be constructed from two traces 45. In some embodiments, the discrete inductor 230 can have a rectangular shape. The inductance L of the discrete inductor 230 may be adjusted by changing the dimensions D1 (e.g., width) and D2 (e.g., height) of the inductor 230. For example, the semiconductor die 600 can be redesigned (“spun”) to adjust the dimensions D1 and D2, thus adjusting the inductance of the discrete inductor 230. An increase in D1 or D2 results in an increased inductance L of the discrete inductor 230, because the length of the traces 45 associated with the inductor 230 increases. Conversely, making D1 relatively small (e.g., bringing the sides of the discrete inductor 230 in closer proximity to each other) generally increases the capacitance of the discrete inductor 230.

In some embodiments, bumps 270 may limit the available area for the inductor 230, because the area of the bumps 270 may form an exclusion area for the traces 45 (e.g., the exclusion area may be reserved for solder balls, therefore no components may be placed in this area). Therefore, D1 and D2 may be selected to produce the required inductance without unduly increasing the parasitic capacitance, and with D1 and D2 within the limits imposed by the exclusion area (e.g., locations of bumps 270).

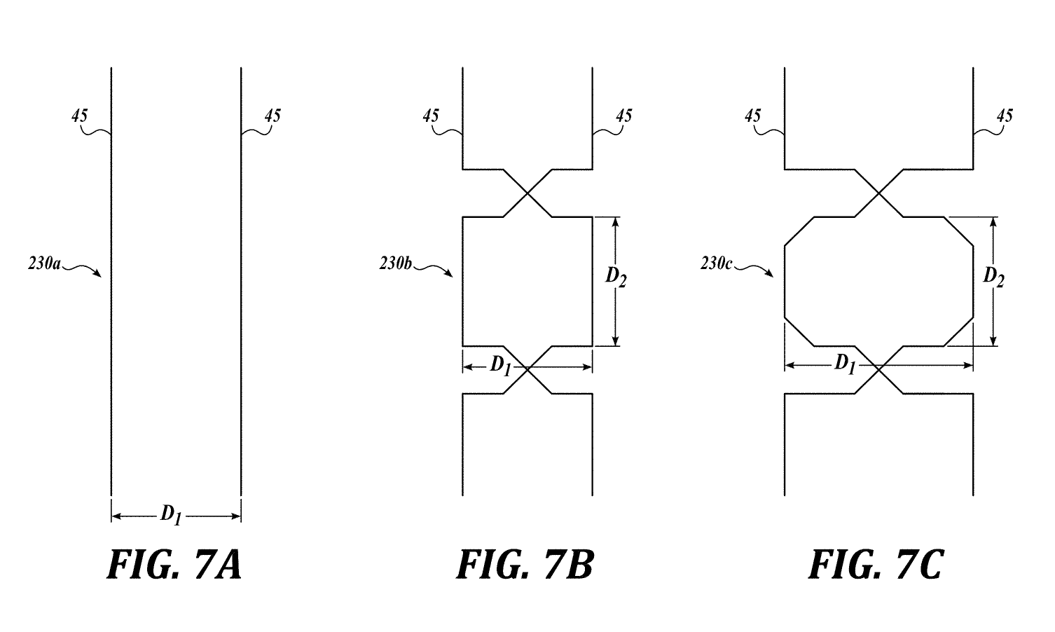

FIGS. 7A to 7C are schematic views of alternative configurations of the inductor 230 in accordance with embodiments of the present disclosure. A pair of traces 45 may comprise the inputs, the outputs, and the inductors 230a/230b/230c. FIG. 7A shows two traces 45 that form an inductor 230a. In at least some embodiments, the inductance of the inductor 230a is a function of the width, length, and shape of the traces 45. The corresponding capacitance of the traces 45 is a function of the mutual distance and length of the traces 45.

FIG. 7B shows an inductor 230b having a generally rectangular shape formed by the traces 45. Inductor 230b may be similar to inductor 230 of FIG. 6B. The inductance of the inductor 230b may be tunable by changing the dimensions of the rectangle (e.g., D1 and D2) and the width of the traces 45. FIG. 7C shows an inductor 230c having an octagonal shape formed by the traces 45. The inductance of the inductor 230c can be tuned by changing the dimensions of the octagon and the width of the traces 45 (e.g., D1 and D2). Each of the inductors 230a-230c may have multiple inputs and multiple outputs at opposing sides of the inductor's shape. In alternative embodiments, the inductor 230, 230a, 230b, or 230c may be a variety of shapes such as, but not limited to, circular, oval, spiral, bent traces, undulating or meandering traces, geometric shape, non-geometric shape, or any other shape that produces the desired inductance and capacitance within the available space or area.

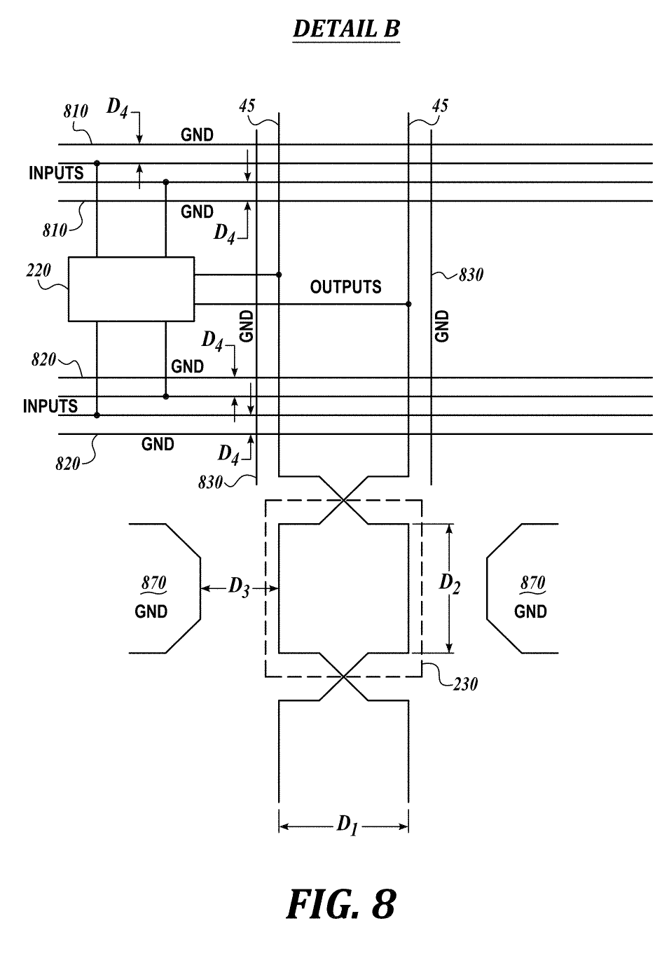

FIG. 8 illustrates an alternative embodiment for implementation of the phase shifter 220 electrically coupled to the inductor 230 in the distributed phase shifter array, in which grounding may be included to facilitate electrical isolation. One or more ground lines (e.g., ground lines 810, 820, and/or 830) may be included to reduce or prevent undesirable electrical coupling and/or beam pulling, which, if present, may result in phase error.

In some embodiments, ground lines 810 and 820 may be included around or on either sides of respective input lines. Ground lines 810 and 820 may also be referred to as groundings, ground lines, or input ground lines. Ground lines 830 may be included around or on either sides of output lines. Ground lines 830 may also be referred to as groundings, ground lines, or output ground lines. A distance D4 between the adjacent input line and ground line 810 or 820 may be variable. The thickness of ground lines 810, 820 may also vary.

Bumps 870 may comprise ground or grounding bumps. A distance D3 between the inductor 230 and bump 870 (distance D3 may be defined on one or both sides of the inductor 230 to respective bump 870) may be varied and (further) define an exclusion area associated with the inductor 230, as discussed above.

Although ground lines 810, 820, 830 and ground bumps 870 are shown in association with a phase shifter 220 and inductor 230, it is understood that fewer than all of the ground lines 810, 820, 830, and ground bumps 870 may be implemented within a distributed phase shifter array.

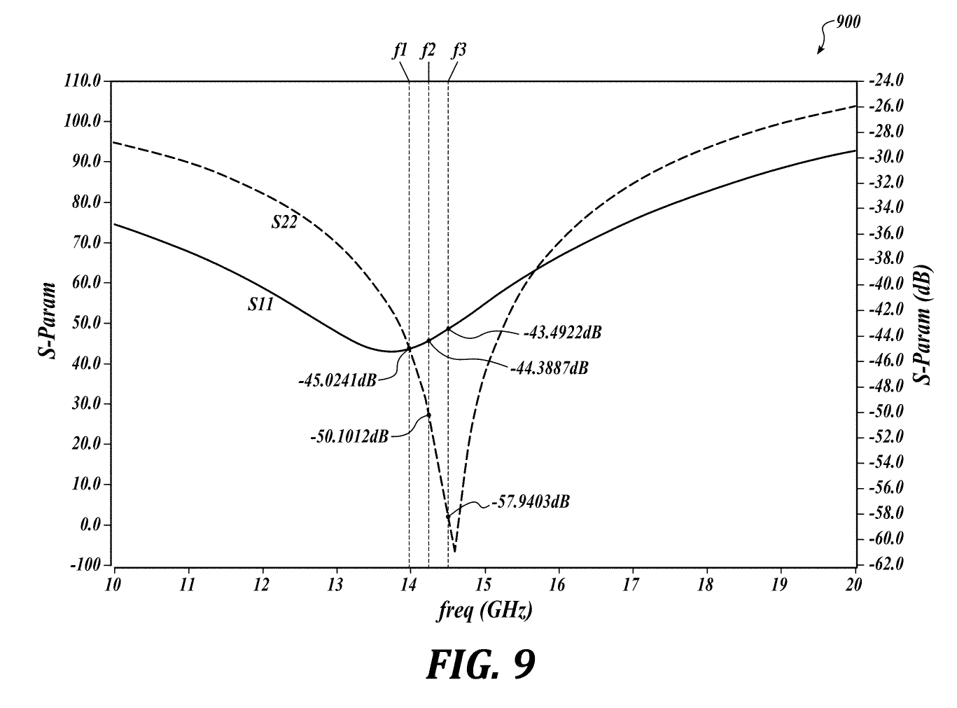

FIG. 9 shows a graph 900 of S-parameters as a function of frequency in accordance with an embodiment of the present disclosure. The graph 900 illustrates simulation results obtained with an embodiment of the distributed phase shifter array. The horizontal axis shows a range of simulated RF frequencies from 10 GHz to 20 GHz. The vertical axis shows S parameters: the input port voltage reflection coefficient S₁₁ and the output port voltage reflection coefficient S₂₂. In particular, the vertical axis to the left shows the value of the S parameters, and the vertical axis to the right shows the logarithm of the S parameters in decibel (dB). The simulated frequency band for the RF signals of interest is from f₁=14 GHz to f₃=14.5 GHz and centered at f₂=14.25 GHz. The simulation results show S₁₁ of about −45 dB at f₁ to about −43.5 dB at f₃, indicating a relatively low input return loss of the input RF signal. Similarly, S₂₂ ranges from about −45 dB at f₁ to about −58 dB at f₃, indicating a relatively low output return loss. In at least some embodiments, the discrete inductors 230, the traces 45, tunable balun transformers 244, and/or resistors 240 may be tuned to adjust the S parameters of the receiver (e.g., the IC chip) for the range of RF frequencies of interest.

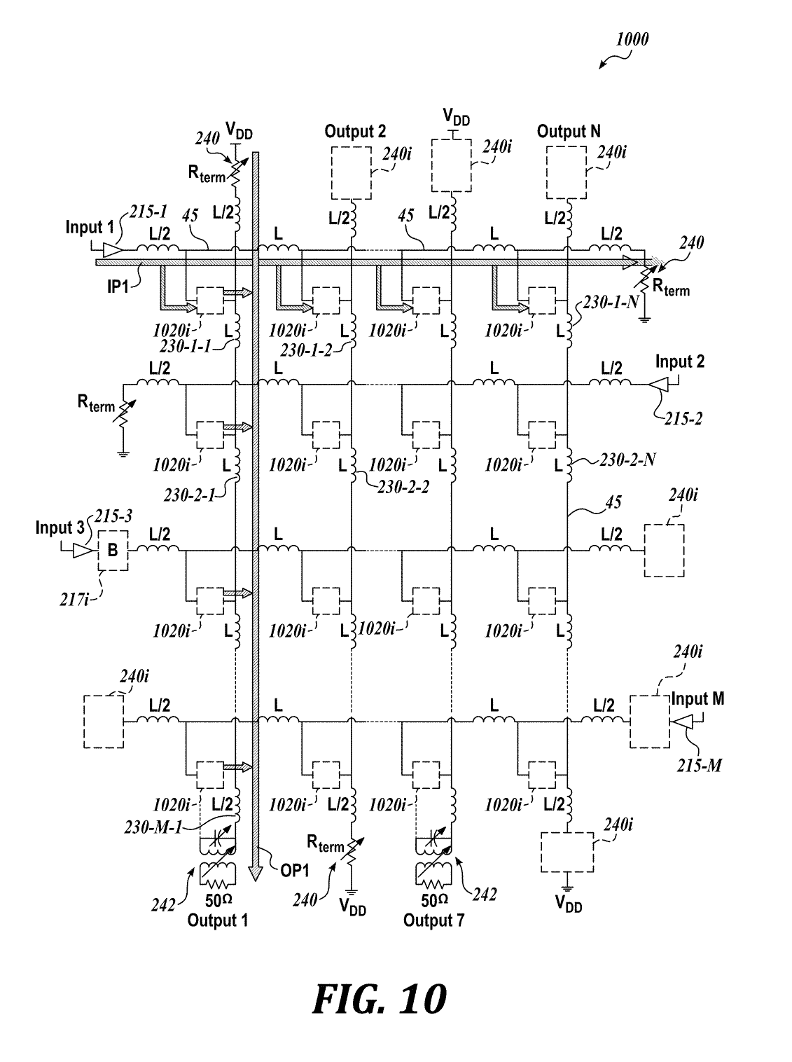

FIG. 10 shows a distributed array 1000, in which phase shifters 220, as shown in FIG. 4, may be replaced with components or elements 1020i in accordance with alternative embodiments of the present disclosure. Distributed array 1000 may be implemented in a single IC chip or semiconductor die. In some embodiments, each of the components/elements 1020i may comprise a component different from phase shifters and which may be the same or different from each other. For example, each of the components/elements 1020i may comprise an amplifier, a LNA, a PA, a filter, an active electrical component, a passive electrical component (e.g., inductor, capacitor, resistor, etc.), and/or the like. Each of the components/elements 1020i may alternatively comprise an electrically conductive trace, in which the distributed array 1000 may comprise compact distributed routing of signals, e.g., RF signals. In other embodiments, each of the components/elements 1020i may comprise more than one component, such as a plurality of phase shifters to receive and/or transmit RF signals associated with interspersed antenna element configuration in the antenna lattice 120 (e.g., antenna elements 122i comprising two or more sets of antenna elements operating at different frequencies from each other). Components/elements 1020i may also be referred to as electrical elements or electrical components.

In this manner, each input RF signal of a plurality of input RF signals may be split within a row and after processing (e.g., phase shifting), combined in columns based on a distributed architecture. The input and output lines, processing components (e.g., phase shifters), and associated electrical components or circuitry (e.g., termination components, inductors, etc.) may be packaged in a compact design within an IC chip or semiconductor die, rather than having a plurality of chips such as a single beamformer per chip. Associated electrical components or circuitry may include use of existing structures within the distributed array, such as, but not limited to, the traces designed to be equivalent inductors, parasitic capacitance associated with phase shifters used as equivalent capacitors, and the like. Such electrical components or circuitry address electrical/circuit requirements within the distributed array, making it possible to split and recombine RF signals as discussed herein.

Illustrative examples of the devices, systems, and methods of various embodiments disclosed herein are provided below. An embodiment of the devices, systems, and methods may include any one or more, and any combination, of the examples described below.

1. An apparatus comprising:

a two-dimensional (2-D) array of phase shifters including a first plurality of the phase shifters and a second plurality of the phase shifters,

wherein the first plurality of the phase shifters is arranged in a first direction of the 2-D array of phase shifters, and wherein the first plurality of the phase shifters is electrically coupled to a first radio frequency (RF) input,

wherein the second plurality of the phase shifters is arranged in a second direction of the 2-D array of phase shifters, and wherein the second plurality of the phase shifters is electrically coupled to a first radio frequency (RF) output, and

wherein the first and second directions intersect each other.

2. The apparatus of example 1, wherein the 2-D array of phase shifters includes a third plurality of the phase shifters and a fourth plurality of the phase shifters,

wherein the third plurality of the phase shifters is arranged in a third direction of the 2-D array of phase shifters parallel with the first direction, and wherein the third plurality of the phase shifters is electrically coupled to a third RF input,

wherein the fourth plurality of the phase shifters is arranged in a fourth direction of the 2-D array of phase shifters parallel with the second direction, and wherein the fourth plurality of the phase shifters is electrically coupled to a second RF output,

wherein the third direction intersects the second and fourth directions, and

wherein the fourth direction intersects the first and third directions.

3. The apparatus of any of examples 1-2, wherein one or both of the first and third directions are opposite signal traversal directions from each other and the second and fourth directions are opposite signal traversal directions from each other.

4. The apparatus of any of exampes 1-3, wherein the 2-D array of phase shifters is arranged on a single semiconductor die.

5. The apparatus of any of exampes 1-4, further comprising: a 2-D array of inductors, wherein each inductor of the 2-D array of inductors is electrically coupled to a respective phase shifter of the 2-D array of phase shifters.

6. The apparatus of any of exampes 1-5, wherein at least one inductor of the 2-D array of inductors comprises one or more traces of the semiconductor die.

7. The apparatus of any of exampes 1-6, wherein at least one inductor of the 2-D array of inductors comprises a tunable or variable inductor.

8. The apparatus of any of exampes 1-7, wherein at least one inductor of the 2-D array of inductors has a rectangular shape, an octagonal shape, a circular shape, an oval shape, a spiral shape, a geometric shape, a non-geometric shape, or a shape made from traces.

9. The apparatus of any of exampes 1-8, wherein at least one inductor of the 2-D array of inductors has multiple inputs at a first side and multiple outputs at a second side.

10. The apparatus of any of exampes 1-9, wherein an inductance associated with the at least one inductor is adjustable by changing one or more of a length, a width (D1), and a height (D2) of the at least one inductor.

11. The apparatus of any of exampes 1-10, wherein the semiconductor die includes multiple 8×8 2-D arrays.

12. The apparatus of any of exampes 1-11, wherein the semiconductor die includes multiple 24×24 2-D arrays.

13. The apparatus of any of exampes 1-12, wherein the 2-D array of phase shifters comprises a differential 2-D array.

14. The apparatus of any of exampes 1-13, wherein the 2-D array of phase shifters comprises a single-ended 2-D array.

15. The apparatus of any of exampes 1-14, wherein the 2-D array of phase shifters includes single ended and differentially ended phase shifters.

16. The apparatus of any of exampes 1-15, further comprising:

a first tunable termination electrically coupled to the first plurality of the phase shifters; and

a second tunable termination electrically coupled to the second plurality of the phase shifters.

17. The apparatus of any of exampes 1-16, wherein the first tunable termination is a tunable or variable resistor.

18. The apparatus of any of exampes 1-17, wherein the second tunable termination is a balun transformer on one side of the second plurality of the phase shifters, and further comprising a fourth tunable termination on a side of the second plurality of the phase shifters opposite the one side, wherein the fourth tunable termination is a tunable resistor.

19. The apparatus of any of exampes 1-18, wherein the first tunable termination is a terminating transformer comprising a combination of an inductor and a tunable capacitor on one side of the first plurality of the phase shifters, and further comprising a third tunable termination on a side of the first plurality of the phase shifters opposite the one side, wherein the third tunable termination is a tunable resistor.

20. The apparatus of any of exampes 1-19, wherein the first and second tunable terminations are single ended.

21. The apparatus of any of exampes 1-20, wherein the first and second tunable terminations are differential ended.

22. The apparatus of any of exampes 1-21, further comprising a low noise amplifier (LNA) connected to the first plurality of the phase shifters.

23. The apparatus of any of exampes 1-22, wherein the first tunable termination is connected to the LNA on one side of the first plurality of the phase shifters, and further comprising a third tunable termination connected to a side of the first plurality of the phase shifters opposite to the one side.

24. The apparatus of any of exampes 1-23, wherein the second tunable termination is connected to one side of the second plurality of the phase shifters, and further comprising a fourth tunable termination connected to a side of the second plurality of the phase shifters opposite to the one side.

25. The apparatus of any of exampes 1-24, further comprising an antenna element connected to the LNA, and wherein the 2-D array of phase shifters and the LNA are included in a semiconductor die and the antenna element is excluded from the semiconductor die.

26. The apparatus of any of exampes 1-25, further comprising:

a first buffer electrically coupled to the first plurality of the phase shifters; and

a second buffer electrically coupled to the second plurality of the phase shifters.

27. The apparatus of any of exampes 1-26, wherein at least one phase shifter of the 2-D array of phase shifters is gain-tunable.

28. The apparatus of any of exampes 1-27, wherein the phase shifters of the 2-D array of phase shifters are vector modulator phase shifters.

29. The apparatus of any of exampes 1-28, wherein the 2-D array of phase shifters is included in a receiver of a phased antenna array system.

30. The apparatus of any of exampes 1-29, wherein the 2-D array of phase shifters is included in a transmitter of a phased antenna array system.

31. The apparatus of any of exampes 1-30, wherein the 2-D array of phase shifters is disposed between a plurality of antenna elements and a multiplex feed network.

32. A method for phased array beamforming, the method comprising:

receiving a first radio frequency (RF) input signal;

phase shifting the first RF input signal by a first plurality of phase shifters into a first plurality of phase-shifted RF signals;

receiving a second RF input signal;

phase shifting the second RF input signal by a second plurality of phase shifters into a second plurality of phase-shifted RF signals;

combining a first phase-shifted RF signal from the first plurality of phase-shifted RF signals with a first phase-shifted RF signal from the second plurality of phase-shifted RF signals into a first RF output signal; and

combining a second phase-shifted RF signal from the first plurality of phase-shifted RF signals with a second phase-shifted RF signal from the second plurality of phase-shifted RF signals into a second RF output signal,

wherein the first and second pluralities of phase shifters are arranged in a two-dimensional (2-D) array on a semiconductor die, and wherein the semiconductor die includes a 2-D array of inductors electrically coupled to the 2-D array of the phase shifters.

33. The method of example 32, wherein the phase shifters of the first and second pluralities of phase shifters are gain-tunable.

34. The method of any of examples 32-33, wherein the semiconductor die comprises a receiver or a portion of the receiver.

35. The method of any of examples 32-34, wherein receiving the first RF input signal comprises receiving the first RF input signal from a first antenna, wherein receiving the second RF input signal comprises receiving the second RF input signals from a second antenna different from the first antenna, and wherein the first RF output signal is associated with a first beam of a plurality of beams.

36. The method of any of examples 32-35, wherein the semiconductor die comprises a transmitter or a portion of the transmitter.

37. The method of any of examples 32-36, wherein receiving the first and second RF input signals comprises receiving the first and second RF input signals from a modulator, and wherein the first RF output signal is to be emitted by a first antenna.

38. The method of any of examples 32-37, wherein at least one inductor of the 2-D array of inductors is tunable.

39. The method of any of examples 32-38, wherein at least one inductor of the 2-D array of inductors comprises one or more interconnect lines included in the semiconductor die and configured to electrically couple one or more of inputs lines, output lines, the first plurality of phase shifters, and the second plurality of phase shifters to each other.

40. The method of any of examples 32-39, wherein each phase shifter of the first plurality of phase shifters is associated with a respective RF beam of a plurality of RF beams.

41. An apparatus comprising:

a two-dimensional (2-D) array of electrical elements including a first plurality of the electrical elements and a second plurality of the electrical elements,

wherein the first plurality of the electrical elements is arranged in a first direction of the 2-D array of electrical elements, and wherein the first plurality of the electrical elements is electrically coupled to a first radio frequency (RF) input,

wherein the second plurality of the electrical elements is arranged in a second direction of the 2-D array of electrical elements, and wherein the second plurality of the electrical elements is electrically coupled to a first radio frequency (RF) output, and

wherein the first and second directions intersect each other.

42. The apparatus of any of examples 2-31 and 41, wherein the 2-D array of electrical elements includes a third plurality of the electrical elements and a fourth plurality of the electrical elements,

wherein the third plurality of the electrical elements is arranged in a third direction of the 2-D array of electrical elements parallel with the first direction, and wherein the third plurality of the electrical elements is electrically coupled to a third RF input,

wherein the fourth plurality of the electrical elements is arranged in a fourth direction of the 2-D array of electrical elements parallel with the second direction, and wherein the fourth plurality of the electrical elements is electrically coupled to a second RF output,

wherein the third direction intersects the second and fourth directions, and

wherein the fourth direction intersects the first and third directions.

43. The apparatus of any of examples 2-31 and 41-42, wherein one or both of the first and third directions are opposite signal traversal directions from each other and the second and fourth directions are opposite signal traversal directions from each other.

44. The apparatus of any of examples 2-31 and 41-43, wherein the 2-D array of electrical elements is arranged on a single semiconductor die.

45. The apparatus of any of examples 2-31 and 41-44, further comprising a 2-D array of termination elements, wherein each termination element of the 2-D array of termination elements is electrically coupled to a respective electrical element of the 2-D array of electrical elements.

46. The apparatus of any of examples 2-31 and 41-45, wherein each electrical element of the 2-D array of electrical elements comprises one or more of an amplifier, a low noise amplifier (LNA), a power amplifier (PA), a filter, an inductor, a capacitor, a resistor, an active electrical component, and a passive electrical component.

47. The apparatus of any of examples 2-31 and 41-46, wherein each electrical element of the 2-D array of electrical elements comprises one or more of a phase shifter and an active electrical component.

48. The apparatus of any of examples 2-31 and 41-47, wherein each electrical element of the 2-D array of electrical elements comprises an electrically conductive trace.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

The embodiments of the invention in which an exclusive property or privilege is claimed are defined as follows:

1. An apparatus comprising:
a two-dimensional (2-D) array of phase shifters including a first plurality of the phase shifters and a second plurality of the phase shifters,
wherein the first plurality of the phase shifters is arranged in a first direction of the 2-D array of phase shifters, and wherein the first plurality of the phase shifters is electrically coupled to a first radio frequency (RF) input,
wherein the second plurality of the phase shifters is arranged in a second direction of the 2-D array of phase shifters, and wherein the second plurality of the phase shifters is electrically coupled to a first radio frequency (RF) output, and
wherein the first and second directions intersect each other.

2. The apparatus of claim 1, wherein the 2-D array of phase shifters includes a third plurality of the phase shifters and a fourth plurality of the phase shifters,
wherein the third plurality of the phase shifters is arranged in a third direction of the 2-D array of phase shifters parallel with the first direction, and wherein the third plurality of the phase shifters is electrically coupled to a third RF input,
wherein the fourth plurality of the phase shifters is arranged in a fourth direction of the 2-D array of phase shifters parallel with the second direction, and wherein the fourth plurality of the phase shifters is electrically coupled to a second RF output,
wherein the third direction intersects the second and fourth directions, and
wherein the fourth direction intersects the first and third directions.

3. The apparatus of claim 2, wherein one or both of the first and third directions are opposite signal traversal directions from each other and the second and fourth directions are opposite signal traversal directions from each other.

4. The apparatus of claim 1, wherein the 2-D array of phase shifters is arranged on a single semiconductor die.

5. The apparatus of claim 4, further comprising:
a 2-D array of inductors, wherein each inductor of the 2-D array of inductors is electrically coupled to a respective phase shifter of the 2-D array of phase shifters.

6. The apparatus of claim 5, wherein at least one inductor of the 2-D array of inductors comprises one or more traces of the semiconductor die.

7. The apparatus of claim 5, wherein at least one inductor of the 2-D array of inductors comprises a tunable or variable inductor.

8. The apparatus of claim 5, wherein at least one inductor of the 2-D array of inductors has a rectangular shape, an octagonal shape, a circular shape, an oval shape, a spiral shape, a geometric shape, a non-geometric shape, or a shape made from traces.

9. The apparatus of claim 5, wherein at least one inductor of the 2-D array of inductors has multiple inputs at a first side and multiple outputs at a second side.

10. The apparatus of claim 9, wherein an inductance associated with the at least one inductor is adjustable by changing one or more of a length, a width (D1), and a height (D2) of the at least one inductor.

11. The apparatus of claim 4, wherein the semiconductor die includes multiple 8×8 2-D arrays.

12. The apparatus of claim 4, wherein the semiconductor die includes multiple 24×24 2-D arrays.

13. The apparatus of claim 1, wherein the 2-D array of phase shifters comprises a differential 2-D array.

14. The apparatus of claim 1, wherein the 2-D array of phase shifters comprises a single-ended 2-D array.

15. The apparatus of claim 1, wherein the 2-D array of phase shifters includes single ended and differentially ended phase shifters.

16. The apparatus of claim 1, further comprising:
a first tunable termination electrically coupled to the first plurality of the phase shifters; and
a second tunable termination electrically coupled to the second plurality of the phase shifters.

17. The apparatus of claim 16, wherein the first tunable termination is a tunable or variable resistor.

18. The apparatus of claim 16, wherein the second tunable termination is a balun transformer on one side of the second plurality of the phase shifters, and further comprising a fourth tunable termination on a side of the second plurality of the phase shifters opposite the one side, wherein the fourth tunable termination is a tunable resistor.

19. The apparatus of claim 16, wherein the first tunable termination is a terminating transformer comprising a combination of an inductor and a tunable capacitor on one side of the first plurality of the phase shifters, and further comprising a third tunable termination on a side of the first plurality of the phase shifters opposite the one side, wherein the third tunable termination is a tunable resistor.

20. The apparatus of claim 16, wherein the first and second tunable terminations are single ended.

21. The apparatus of claim 16, wherein the first and second tunable terminations are differential ended.

22. The apparatus of claim 16, further comprising a low noise amplifier (LNA) connected to the first plurality of the phase shifters.

23. The apparatus of claim 22, wherein the first tunable termination is connected to the LNA on one side of the first plurality of the phase shifters, and further comprising a third tunable termination connected to a side of the first plurality of the phase shifters opposite to the one side.

24. The apparatus of claim 22, wherein the second tunable termination is connected to one side of the second plurality of the phase shifters, and further comprising a fourth tunable termination connected to a side of the second plurality of the phase shifters opposite to the one side.

25. The apparatus of claim 22, further comprising an antenna element connected to the LNA, and wherein the 2-D array of phase shifters and the LNA are included in a semiconductor die and the antenna element is excluded from the semiconductor die.

26. The apparatus of claim 1, further comprising:
a first buffer electrically coupled to the first plurality of the phase shifters; and
a second buffer electrically coupled to the second plurality of the phase shifters.

27. The apparatus of claim 1, wherein at least one phase shifter of the 2-D array of phase shifters is gain-tunable.

28. The apparatus of claim 1, wherein the phase shifters of the 2-D array of phase shifters are vector modulator phase shifters.

29. The apparatus of claim 1, wherein the 2-D array of phase shifters is included in a receiver of a phased antenna array system.

30. The apparatus of claim 1, wherein the 2-D array of phase shifters is included in a transmitter of a phased antenna array system.

31. The apparatus of claim 1, wherein the 2-D array of phase shifters is disposed between a plurality of antenna elements and a multiplex feed network.

32. A method for phased array beamforming, the method comprising:
receiving a first radio frequency (RF) input signal;
phase shifting the first RF input signal by a first plurality of phase shifters into a first plurality of phase-shifted RF signals;
receiving a second RF input signal;
phase shifting the second RF input signal by a second plurality of phase shifters into a second plurality of phase-shifted RF signals;
combining a first phase-shifted RF signal from the first plurality of phase-shifted RF signals with a first phase-shifted RF signal from the second plurality of phase-shifted RF signals into a first RF output signal; and
combining a second phase-shifted RF signal from the first plurality of phase-shifted RF signals with a second phase-shifted RF signal from the second plurality of phase-shifted RF signals into a second RF output signal,
wherein the first and second pluralities of phase shifters are arranged in a two-dimensional (2-D) array on a semiconductor die, and wherein the semiconductor die includes a 2-D array of inductors electrically coupled to the 2-D array of the phase shifters.

33. The method of claim 32, wherein the phase shifters of the first and second pluralities of phase shifters are gain-tunable.

34. The method of claim 32, wherein the semiconductor die comprises a receiver or a portion of the receiver.

35. The method of claim 32, wherein receiving the first RF input signal comprises receiving the first RF input signal from a first antenna, wherein receiving the second RF input signal comprises receiving the second RF input signals from a second antenna different from the first antenna, and wherein the first RF output signal is associated with a first beam of a plurality of beams.

36. The method of claim 32, wherein the semiconductor die comprises a transmitter or a portion of the transmitter.

37. The method of claim 32, wherein receiving the first and second RF input signals comprises receiving the first and second RF input signals from a modulator, and wherein the first RF output signal is to be emitted by a first antenna.

38. The method of claim 32, wherein at least one inductor of the 2-D array of inductors is tunable.

39. The method of claim 32, wherein at least one inductor of the 2-D array of inductors comprises one or more interconnect lines included in the semiconductor die and configured to electrically couple one or more of inputs lines, output lines, the first plurality of phase shifters, and the second plurality of phase shifters to each other.

40. The method of claim 32, wherein each phase shifter of the first plurality of phase shifters is associated with a respective RF beam of a plurality of RF beams.

41. An apparatus comprising:
a two-dimensional (2-D) array of electrical elements including a first plurality of the electrical elements and a second plurality of the electrical elements,
wherein the first plurality of the electrical elements is arranged in a first direction of the 2-D array of electrical elements, and wherein the first plurality of the electrical elements is electrically coupled to a first radio frequency (RF) input,
wherein the second plurality of the electrical elements is arranged in a second direction of the 2-D array of electrical elements, and wherein the second plurality of the electrical elements is electrically coupled to a first radio frequency (RF) output, and
wherein the first and second directions intersect each other.

42. The apparatus of claim 41, wherein the 2-D array of electrical elements includes a third plurality of the electrical elements and a fourth plurality of the electrical elements,
wherein the third plurality of the electrical elements is arranged in a third direction of the 2-D array of electrical elements parallel with the first direction, and wherein the third plurality of the electrical elements is electrically coupled to a third RF input,
wherein the fourth plurality of the electrical elements is arranged in a fourth direction of the 2-D array of electrical elements parallel with the second direction, and wherein the fourth plurality of the electrical elements is electrically coupled to a second RF output,
wherein the third direction intersects the second and fourth directions, and
wherein the fourth direction intersects the first and third directions.

43. The apparatus of claim 42, wherein one or both of the first and third directions are opposite signal traversal directions from each other and the second and fourth directions are opposite signal traversal directions from each other.

44. The apparatus of claim 41, wherein the 2-D array of electrical elements is arranged on a single semiconductor die.

45. The apparatus of claim 41, further comprising a 2-D array of termination elements, wherein each termination element of the 2-D array of termination elements is electrically coupled to a respective electrical element of the 2-D array of electrical elements.

46. The apparatus of claim 41, wherein each electrical element of the 2-D array of electrical elements comprises one or more of an amplifier, a low noise amplifier (LNA), a power amplifier (PA), a filter, an inductor, a capacitor, a resistor, an active electrical component, and a passive electrical component.

47. The apparatus of claim 41, wherein each electrical element of the 2-D array of electrical elements comprises one or more of a phase shifter and an active electrical component.

48. The apparatus of claim 41, wherein each electrical element of the 2-D array of electrical elements comprises an electrically conductive trace.
